(19) United States
(12) Patent Application Publication
(10) Pub. No.: US 2015/0112767 A1
(43) Pub. Date: Apr. 23, 2015

(54) SYSTEM AND METHOD FOR USING NETWORK MOBILITY EVENTS TO BUILD ADVERTISING DEMOGRAPHICS

(71) Applicant: CISCO TECHNOLOGY, INC., San Jose, CA (US)

(72) Inventors: Kevin D. Shatzkamer, Hingham, MA (US); Saileshwar Krishnamurthy, Palo Alto, CA (US); David A. Maluf, Mountain View, CA (US); Sateesh K. Addepalli, San Jose, CA (US)

(73) Assignee: CISCO TECHNOLOGY, INC., San Jose, CA (US)

(21) Appl. No.: 14/056,514

(22) Filed: Oct. 17, 2013

(51) Int. Cl. G06Q 30/02

(52) U.S. Cl. CPC G06Q 30/0205
USPC 705/7.34

(57) ABSTRACT

An example method is provided in one example embodiment and includes receiving a mobility event message for a first user equipment; determining demographic information for a first subscriber associated with the first user equipment; determining a location of the first subscriber in relation to a first network domain; identifying one or more advertising domains in relation to the location of the first subscriber based on the first network domain; determining a modeling function based on the mobility event message and the location of the first subscriber in relation to the identified advertising domains; updating, based on the modeling function, one or more demographic models for each of the identified one or more advertising domains using the demographic information for the first subscriber; and following the updating, calculating demographic information for all subscribers for each of the updated one or more demographic models for the identified advertising domains.

### TECHNICAL FIELD

This disclosure relates in general to the field of communications and, more particularly, to a system and method for using network mobility events to build advertising demographics.

### BACKGROUND

Advertisers and media providers are interested in developing advertising campaigns that reach broad populations of potential consumers. Mobile communication networks have grown substantially in subscriber base as end users become increasingly connected to mobile wireless environments to conduct business, to shop, to interact with friends, to maintain personal finances, and to perform many other daily functions. Advertisers and media providers are increasingly interested in learning behaviors of potential consumers to develop advertising campaigns. There are significant challenges in learning behaviors of potential consumers, particularly in the context of mobile communication networks.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system to facilitate using network mobility events to build advertising demographics according to one embodiment of the present disclosure;

FIG. 2 is a simplified block diagram illustrating details associated with one potential embodiment of the communication system;

FIG. 3 is a simplified block diagram illustrating other details associated with one potential embodiment of the communication system;

FIG. 4 is a simplified block diagram illustrating details associated with one example use case in a particular implementation of the communication system;

FIG. 5 is simplified block diagram illustrating other details associated with another example use case in a particular implementation of the communication system;

FIG. 6 is a simplified block diagram illustrating yet other details associated with yet another example use case in a particular implementation of the communication system;

FIG. 7 is a simplified flow diagram illustrating example operations associated with building advertising demographics models using network mobility events in one embodiment of the communication system; and

FIG. 8 is simplified block diagram illustrating yet other details associated with yet another example use case in a particular implementation of example communication systems.

### DETAILED DESCRIPTION OF EXAMPLE EMBODIMENTS

### Overview

A method for a communication network is provided in one example embodiment and may include receiving a mobility event message for a first user equipment; determining demographic information for a first subscriber associated with the first user equipment based on subscription information for the first subscriber; determining a location of the first subscriber in relation to a first network domain; identifying one or more advertising domains in relation to the location of the first subscriber based on the first network domain, wherein each of the one or more advertising domains are aligned to one or more network domains of the communication network; determining a modeling function based on the mobility event message and the location of the first subscriber in relation to the one or more identified advertising domains; updating, based on the modeling function, one or more demographic models for each of the one or more identified advertising domains using the demographic information for the first subscriber, wherein each of the one or more demographic models may include information for geographic locations within each of the one or more network domains and wherein each of the one or more demographic models further includes demographic information for a plurality of other subscribers in each of the one or more identified advertising domains; and following the updating, calculating demographic information for all subscribers for each of the one or more updated demographic models for each of the one or more identified advertising domains. In some cases, a reach metric can be calculated for a particular demographic of subscribers.

In some cases the mobility event message can include a handover message, a location reporting procedure message, a location management procedure message or a subscriber data handling message. In one case, the receiving can be performed in-band with the mobility event message, and, in other cases, the receiving can be performed out-of-band with the mobility event message. In one instance, the mobility event message may be received by a port sniffer including an analytic engine.

In another instance, the method can include storing location information for the first subscriber based on the location of the first subscriber in relation to the one or more advertising domains. In one instance the one or more demographic models may further include a plurality of bitmaps compressed into a bitmap index and wherein the bitmap index includes the geographic locations indexed to the one or more network domains for each of the one or more identified advertising domains. In various instances, the network domains can include one or more cell locations, one or more tracking areas, one or more routing areas or one or more paging areas.

In some instances, the modeling function can include a create modeling function, wherein the updating the one or more demographic models using the demographic information for the first subscriber includes adding the demographic information for the first subscriber to at least one demographic model for at least one of the identified advertising domains; a change modeling function, wherein the updating the one or more demographic models using the demographic information for the first subscriber includes adding the demographic information for the first user to at least one demographic model for at least one of the identified advertising domains and removing the demographic information for the first user from at least one other demographic model for at least one of the identified advertising domains; or a delete modeling function, wherein the updating the one or more demographic models using the demographic information for the first subscriber includes removing the demographic information for the first subscriber from at least one demographic model for at least one of the identified advertising domains.

In yet other instances, the method can include communicating advertising content to the first subscriber using a second network different than the communication network based on the location of the subscriber within one or more of the identified advertising domains. In yet another instance, method can include communicating advertising content to the first subscriber using a linear television network. In some cases, the method can include communicating advertising content to a particular demographic of subscribers using a second network different than the communication network; and calculating a frequency metric for the particular demographic following the communicating.

### Example Embodiments

Today's advertising models remain fairly stagnant, relying on a simple set of demographics to drive advertising campaigns. These demographics may generally consist of: country, state/province, zip/postal code, age, height, body type, hair color, gender, education, profession, income, car ownership, pets, marital status, number of children, looking to marry soon, religion, ethnicity, search type, smoking habits, browser type, games and puzzles, drinking habits, login count, session depth, ads clicked, intent, etc. While the standard method of developing advertising campaign based on simple demographics is often used by the advertising industry, there is interest in driving more location-based (hyper-local) and personalization (hyper-targeting). Today's advertising sales models are segmented not just by demographics, but “buy side” models are targeted to advertising domains. For instance, Manhattan may have anywhere from 18 to 26 advertising domains. A set-top box for a television in Domain A and a set-top box for a television in Domain B, for instance, might see different advertising in the same timeslot during the same show on the same channel. The advertising “domain” model is one that is likely to continue. Although hyper-X targeting models may currently have limited applicability in the marketplace, there is benefit in enriching the existing demographics/domain model by understanding mobility events and/or mobility patterns of mobile, subscribers. For the purposes of the present disclosure the terms “ad” and “advertising” may be used interchangeably.

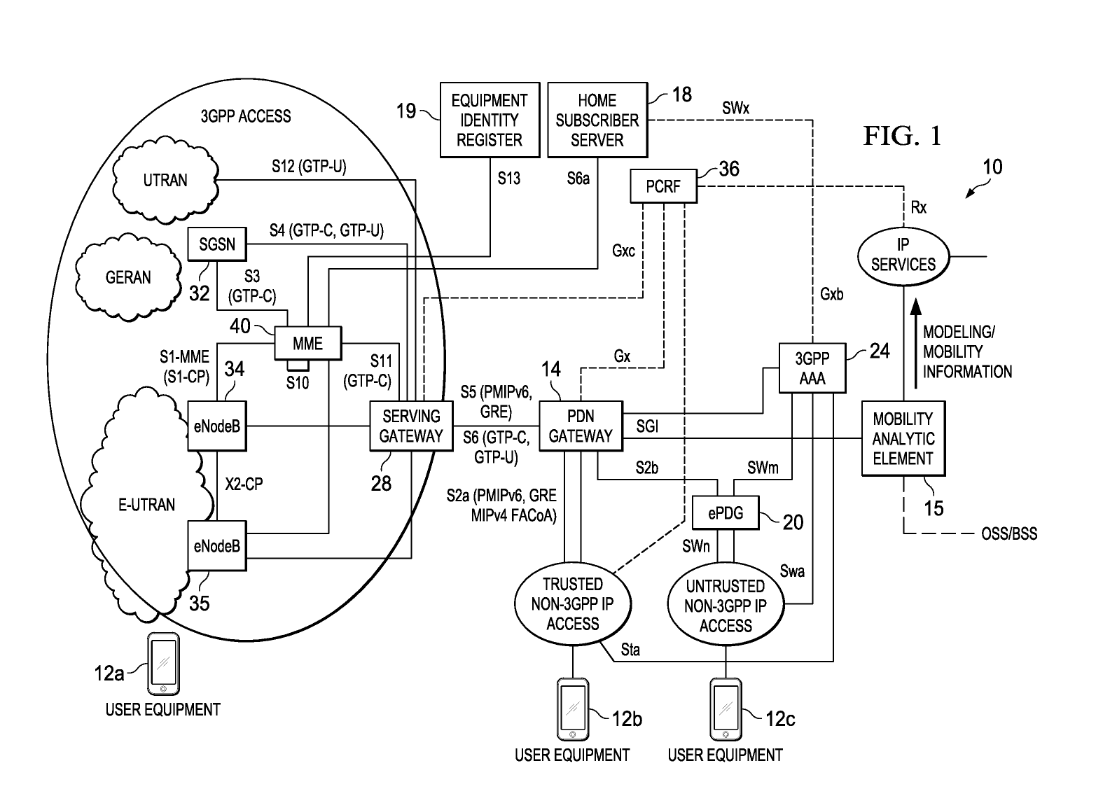

Turning to FIG. 1, FIG. 1 is a simplified block diagram illustrating a communication system 10 to facilitate using network mobility events to build real-time or approximately real-time advertising demographics according to one embodiment of the present disclosure. This particular configuration may be tied to the 3rd Generation Partnership Project (3GPP) Evolved Packet System (EPS) architecture, also sometimes referred to as the Long-term Evolution (LTE) EPS architecture. Alternatively, the depicted architecture may be applicable to other environments equally.

The example architecture of FIG. 1 may include multiple end users or subscribers operating user equipment (UE) 12a-c and a packet data network (PDN) gateway (PGW) 14, which has a logical connection to a serving gateway (SGW) 28. Also provided are a home subscriber server (HSS) 18, an equipment identity register (EIR) 19 and an Authentication, Authorization and Accounting (AAA) element 24. The SGW 28 has a logical connection to a first eNodeB 34, a second eNodeB 35 and a Mobility Management Entity (MME) 40. Both SGW 28 and PGW 14 can interface with a Policy and Charging Rules Function (PCRF) 36. PGW 14 may interface with a mobility analytic element (MAE) 15. The MAE 15 may receive subscriber information for the subscribers operating UE 12a-c from one or more operational support system/business support system (OSS/BSS) for one or more network operators and/or service providers that may be associated with the communication system 10. As discussed herein in the present disclosure, the terms ‘user’ and ‘subscriber’ are interchangeable.

Each of the elements of FIG. 1 may couple to one another through simple interfaces (as illustrated) or through any other suitable connection (wired or wireless), which provides a viable pathway for network communications. Additionally, any one or more of these elements may be combined or removed from the architecture based on particular configuration needs. For example, communication system 10 may include a configuration capable of transmission control protocol/Internet protocol (TCP/IP) communications for the transmission or reception of packets in a network. Communication system 10 may also operate in conjunction with a user datagram protocol/IP (UDP/IP) or any other suitable protocol where appropriate and based on particular needs.

In more general terms, 3GPP defines the Evolved Packet System (EPS) as specified in TS 23.401, TS 23.203, TS 29.212, TS 29.274, etc. The EPS generally consists of UE access networks and an Evolved Packet Core (EPC). Access networks may be 3GPP access networks including legacy access networks such as GSM EDGE Radio Access Network (GERAN), UMTS Terrestrial Radio Access Network (UTRAN) or LTE access networks such as Evolved UTRAN (E-UTRAN), or they may be non-3GPP IP access networks such as digital subscriber line (DSL), Cable, WiMAX, code division multiplex access (CDMA) 2000, WiFi, or the Internet.

Radio Access Networks (RANs) in an EPS architecture consist of eNodeBs (also known as eNBs). An eNodeB is generally connected directly to an EPC, as well as to adjacent eNodeBs in the system. Connections with adjacent eNodeBs may allow calls to be routed more directly. An eNodeB is also responsible for selecting an MME for UE, managing radio resources, and making handover decisions for UE. A pair of eNodeBs, a first eNodeB 34 and a second eNodeB 35, are shown in FIG. 1 coupled to MME 40 through an S1-MME (S1-AP) signaling protocol. The S1-AP signaling protocol may be split into control plane signaling through an S1-CP interface and user plane signaling based on GTP user data tunneling (GTP-U). The first and second eNodeBs 34, 35 may communicate over an X2-CP interface to support active mode UE mobility, e.g., handover events for UEs.

Non-3GPP IP access networks can be divided into trusted and untrusted segments. For trusted segments, a viable relationship exists between a service provider and the core network. Trusted IP access networks support mobility, policy and AAA interfaces to the EPC, whereas untrusted networks do not. Instead, access from untrusted access networks is done via an evolved packet data gateway (ePDG) 20, which provides for IPsec security associations to the user equipment over the untrusted IP access network. The ePDG has a logical connection to the PCRF 36 and supports mobility, policy and AAA interfaces to the EPC, similar to the trusted IP access networks.

Also provided in the architecture of FIG. 1 is a series of interfaces, which can offer mobility, policy control, AAA functions and/or charging activities (offline and online) for various network elements. For example, interfaces can be used to exchange point of attachment, location, and/or access data for one or more end users, for example, users operating UE 12a-c. Resource, accounting, location, access network information, network address translation (NAT) control, etc. can be exchanged using a remote authentication dial in user service (RADIUS) protocol or any other suitable protocol where appropriate. Other protocols that can be used in communication system 10 can include a Diameter protocol, service gateway interface (SGI), terminal access controller access-control system (TACACS), TACACS+, etc. RADIUS, Diameter and various interfaces related to communication for the protocols will be discussed in further detail below, as related to various embodiments of the present disclosure.

As shown in FIG. 1, a RADIUS interface, Rx, may be maintained between the operator services and PCRF 36. Through a Diameter-based Gx interface, the PCRF 36 may provision PCC rules for a policy control and enforcement function (PCEF), which may be contained within PGW 14. Communication system 10 may be configured with additional Diameter interfaces to manage policy and control between various elements of the system 10. For example, Diameter interfaces, Gxa, Gxb and Gxc, may be maintained between the PCRF 36 and the trusted/non-trusted IP access points, the ePDG 20, and the SGW 28, respectively. Further Diameter interfaces, SWx, STa (RADIUS/Diameter), SWa and SWm may be maintained between the AM element 24 and the HSS 18, the trusted non-3GPP IP access point, the untrusted non-3GPP access point, and the ePDG 20, respectively. Various additional Diameter interfaces may include S6a between the HSS 18 and the MME 40, S6b between the AAA element 24 and the PGW 14, and SWn between the ePDG 20 and the untrusted non-3GPP access point.

In operation, for example, UE 12a can attach to the network for purposes of establishing a communication session. UE 12a can communicate with, for example, first eNodeB 34 that can further interact with MME 40 to complete some form of authentication for a particular user. MME 40 can interact with SGW 28, which interacts with PGW 14 such that a session can be setup between these components. The first eNodeB 34 can interact with SGW 28 to provide data plane interactions for UE 12a. Tunnels can be established at this juncture, and a suitable IP address can also be issued for this particular user. This process generally involves a default EPS bearer session being created for UE 12a. Dedicated bearer sessions can also be created for various services. Exemplary tunnel protocols such as GPRS tunneling protocol (GTP), which can be separated into control (GTP-C) signaling protocols and user data plane (GTP-U) protocols, are shown in FIG. 1 between various elements of communication system 10. As the session is established, PGW 14 can interact with PCRF 36 to identify policies associated with this particular user, such as a certain QoS setting, bandwidth parameter, latency setting, priority, billing, etc. Similar actions could take place for the second eNodeB 3 if UE 12a were to communicate with the second eNodeB 35.

For the purposes of illustrating the techniques of communication system 10, it is important to understand real-time advertising and targeting that may be used in the communication system 10 shown in FIG. 1. The following contextual information may be viewed as a basis from which the present disclosure may be properly explained. Such information is offered earnestly and for purposes explanation only and, accordingly, should not be construed in a way to limit the broad applications for the present disclosure and its potential applications.

Advertisers typically pay a cost per mille (CPM) for every thousand displays of their advertising content to potential consumers or customers. In addition to the traditional notions of demographics, there are some useful time-sensitive attributes of a mobile user such as current location and current “over the top” (OTT) service being used by the mobile user (e.g., Twitter®, YouTube®, etc.). Today's method of using device data is not ubiquitous, since devices typically only transmit location to (a) an active application, (b) when a device is not dormant. In the case of network data and using mobility events, a consistent, ubiquitous model of understanding location may be possible. For example, today's web-based advertising is based on location of only the subscriber being shown the ad, but hyper-targeting has diminishing returns. Moreover, although much subscriber demographic information may be understood by a mobile carrier, it has not been used to drive new advertising models.

In accordance with one embodiment, communication system 10 can overcome the aforementioned shortcomings (and others) through de-fragmentation of mobility data and location data using mobility events of subscribers to provide a new advertising methodology that can be leveraged to web-pages, linear television and other forms of digital content through which advertising content may be provided to subscribers. By leveraging geo-location mapping based on mobility events, advertisers and ad networks can deliver campaigns targeting a subset of demographics, but the decision-logic as to when to launch the campaign can be determined by mobility events modeled through one or more demographics analytical models. (e.g., when will an advertiser, media provider, advertising network, etc. reach the broadest set of demographics?). In one instance, on the linear TV side, mobility usage events could be beneficial to converged operators that offer both TV and mobile services. In another instance, mobility usage events could be marketed to operators or advertisers to complement their own demographic and/or advertising modeling. By understanding and/or modeling mobility events on a cellular network (or WiFi) and building demographics-based geo-location maps for network and advertising domains, advanced advertising insertion techniques at the cable head-end can be leveraged in a similar campaign format.

The combination of location and OTT services can be used as a “broad brush” targeting channel in order to avoid legitimate concerns regarding hyper-targeting by privacy advocates. In order to improve advertising CPM and drive improvement in ad serving, embodiments of the present disclosure describe example systems and methods to use network mobility events to build real-time or approximately real-time advertising demographics as a means to complement demographics and/or advertising domain analytical models. The use of subscriber mobility events to complement advertising domain modeling to build, maintain and/or update real-time or approximately real-time advertising demographics for one or more ad domains may collectively be referred to as “mobility analytics,” which may be performed by one or more mobility analytic element(s) 15 and/or one or more analytics engine(s) (not shown in FIG. 1, discussed in further detail below) that can be augmented in one or more network nodes, gateways or other network element.

Performing mobility analytics for real-time ad domain analytical modeling may include, but not be limited to, intercepting or receiving a mobility event message for a subscriber; determining an identity of the subscriber; retrieving demographic information for the subscriber based on the subscriber's identity; determining a location of the subscriber based on network domain to identify one or more advertising domains in relation to the subscriber's location; determining a modeling function based on the mobility event message and the location of the first user in relation to the one or more advertising domains and updating the subscriber's demographic information in one or more demographics analytical models for the one or more advertising domains. One or more network domains may be aligned to one or more ad domains for the communication system 10. Demographics analytical models may, of course, be updated for all users/subscribers within one or more advertising domains for the system 10. Following analytical model updates, one or more computations may be performed for particular demographics information across an entire set of data within the analytical models. For instance, the computation may entail an age range, income level, gender, etc. The models may be calculated based on current demographics updates for a current subscriber and past demographics data for all subscribers stored in the models for one or more updated advertising domains.

At any given time, a subscriber in the mobile domain can be classified as: 1) a mobile subscriber identity (ID), typically by International Mobile Subscriber Identity (IMSI), Temporary Mobile Subscriber Identity (TMSI), international mobile station equipment identity (IMEI), or international mobile station equipment identity software version (IMEISV); 2) a subscriber profile that can be maintained by a service provider (SP), which may consist of a set of parameters related to the SP's service offering; 3) a subscriber profile that can be maintained by a content provider (e.g., application) and/or advertiser, which may consist of a set of parameters related to the content offered by the content provider and/or advertiser; and 4) a set of demographics that can be used to define the previously identified subscriber.

The 3GPP standards define a wide range of interfaces, protocols, and messages that can be used to drive new insights into advertising domains. Advertising domains may be mapped or aligned to well-understood 3GPP defined network domains such as, for example, one or more cell tower locations, one or more tracking areas, one or more location or routing areas, one or more paging areas, etc. or may be a sub-set or super-set of the 3GPP-defined network domains. Further, advertising domains in a mobile environment may be aligned to an advertiser's defined geographic segmentation from a fixed or cable environment. In one instance, geographic segmentations may be aligned to zip codes or zip+4 codes or any other geographic segmentation.

In another instance, advertising domains can be mapped to one or more Designated Marketing Areas (DMAs). A DMA may consist of a geographical map that specifies one or more television markets for one or more counties. The DMA may specify which counties are in which television markets. DMAs can be used for determining various information, such as, for example Nielsen ratings related to television viewership for television programming. Nielsen ratings can be used to determine commercial ad rates after ratings, known as sweeps are performed. Television stations can use Nielsen ratings to help set rates for commercial air time on a particular channel for a specified period. Mobility information for one or more users in ad domains overlaid with DMAs can be used to develop targeted television advertising campaigns by modeling additional demographic information for users learned through DMAs.

Geophysical maps may be retrieved from some available application programming interface (API), such as Google Maps®, Mapquest® or the like and may be used to overlay analytical models across advertising domains on geophysical maps, which may, in turn, be correlated with 3GPP network geospatial domains or locations such as, for example, cell sites, tracking area, location or routing area, paging area, combinations thereof or the like. Embodiments of the present disclosure do not preclude any prescriptive definition of the correlation between advertising domains and 3GPP-defined network domains, sub-sets of 3GPP-defined domains, super-sets of 3GPP-defined domains, combinations thereof or the like. The geophysical maps retrieved from an API may contain indexed location information for retailers, businesses or other information from which user information or behaviors may be learned. The geophysical maps may be stored as bitmaps, which may be compressed into a compressed bitmap (CBM) index, which may be stored in a database, memory element or other such storage device. Specific geographic locations on the maps may be indexed to one or more network domains for one or more corresponding advertising domains.

Within defined advertising domains, certain mobility event communications messages for users/subscribers may be monitored, received, intercepted or snooped either through an inline probe (e.g. MAE 15) or a real-time or approximately real-time interface from network elements and used to perform modeling functions on demographics analytic models for the advertising domains, which may, in turn be used to create real-time population and/or demographic maps that may be used for targeted advertising campaigns. Timing for targeted advertising campaigns can be determined based on the analytic models in order to reach certain demographics and/or populations. As used herein, the terms “intercept,” “snoop,” “monitor” and “receive” may be used interchangeably in the context of mobility event messages.

By combining mobility analytic modeling of user mobility events with subscriber demographic information across advertising domains overlaid with one or more geophysical maps, real-time or approximately real-time population and/or demographics maps may be built or maintained for targeted advertising campaigns. The demographics analytical models may leverage compressed bitmap (CBM) custom aggregate indexing to modify real-time counters for one or more demographic models for one or more advertising domains. The use of CBM custom aggregates may provide for composable models to be built, updated and/or maintained for one or more advertising domains. Snapshots of the analytic models may be obtained at certain times by one or more advertisers, media providers, content providers, application providers or the like in order to determine one or more time slots for launching targeted advertising campaigns for ad domains that may have the greatest likelihood to reach one or more specified demographics and/or populations of subscribers with certain advertising content.

Mobility event messages may be monitored for the S1-CP, S6a, S10, S11, S13, and X2-CP interfaces as defined in TS 36.413, TS 29.272, 36.423, etc., which may cover mobility events such as context setup/release, handover request/notify/cancel, location reporting control and/or update/cancel location. Mobility event messages that may be monitored for the S1-CP interface may include handover messages, such as, for example, HANDOVER REQUIRED, HANDOVER REQUEST, HANDOVER NOTIFY, PATH SWITCH REQUEST, HANDOVER CANCEL, eNB STATUS TRANSFER and/or MME STATUS TRANSFER as well as location reporting messages such as LOCATION REPORTING CONTROL and/or LOCATION REPORT. Mobility event messages that may be monitored for the X2-CP interface may include handover messages such as, for example, HANDOVER REQUEST, HANDOVER CANCEL, SN STATUS TRANSFER and/or HANDOVER REPORT. Mobility event messages that may be monitored for the s6a interface may include location management procedure messages such as, for example, UPDATE LOCATION, CANCEL LOCATION and/or PURGE UE as well as subscriber data handling procedure messages such as, for example, INSERT SUBSCRIBER DATA and/or DELETE SUBSCRIBER DATA. Monitoring such mobility event messages, as those described above, may provide for consistent, ubiquitous characterizations of subscriber locations for semi-dormant UE modes in relation to one or more ad domains as may be mapped to one or more corresponding network domains.

In some instances a mobility analytic element including an analytic engine may include an “in-band” proxy function or other function such as bump-in-the-wire deep packet inspection (DPI) or deep content level inspection may be used to intercept, snoop, monitor or receive mobility event messages. By “in-band,” it is meant that mobility event messages may be intercepted, snooped, monitored or received on an interface or at the interface between one or more network nodes, gateways, elements combinations thereof or the like. In other instances, an “out-of-band” function may be augmented using an analytic engine within network nodes, gateways, elements etc., or using a port sniffer augmented with an analytic engine to intercept mobility event messages. By “out-of-band” it is meant that mobility event messages may be intercepted, snooped, monitored or received by aggregating signaling information from within a network node, gateway, element, etc., e.g., off the interface.

Thus, it is understood that, semantically, mobility analytics for one or more network domains and/or one or more advertising domains can be performed across the entire 3GPP communication domain. As described in further detail herein, the architecture of the communication system 10 can cover cases where mobility analytics may be performed using an in-line mobility analytics element, where a network node or gateway vendor seeks to augment node or gateway capabilities with mobility analytics functionality or where a port sniffer is augmented with mobility analytics functionality. Hence, the architecture of communication system 10 can cover multiple realizations for monitoring mobility event messages to build real-time advertising demographics as a means to complement demographics and/or advertising domain analytics modeling.

Mobility event messages may be received for a user by one or more mobility analytic element(s) including analytic engines and/or analytic engine(s) included in one or more network elements or nodes within communication system 10, which may operate to perform a set of modeling functions based on mobility event messages to build real-time or approximately real-time advertising demographics by updating and/or maintaining demographics and/or population analytical models for one or more ad domains. Mobility event messages can largely be categorized as “CREATE,” “CHANGE,” and/or “DELETE” modeling functions. Mobility event messages within the CREATE category may result in additive-type analytical modeling functions being performed. One or more analytic engines within the system 10 may determine a modeling function based on a mobility event message received for a UE and the UE's location in relation to one or more ad domains.

A CREATE category mobility event message may, for example, be associated with a subscriber turning-on their UE or entering into coverage of one or more ad domains. Thus, one or more analytic engines in the system 10 may determine CREATE modeling functions based on intercepting or receiving mobility event messages associated with a subscriber turning on their UE or entering coverage areas of the system that may be associated with one or more ad domains. For CREATE modeling functions, the analytic engine(s) may register the subscriber in the system and the subscriber's information and/or demographic information may be associated with or added to one or more already-established analytical models associated with the one or more ad domains.

The mobile subscriber ID of the subscriber, such as IMSI, TMSI, IMEI or the like may be correlated to the subscriber's profile stored in the OSS/BSS system, which may identify the user by a larger set of information (e.g., address, name, email address, etc.). The subscriber may further be correlated to any profile and/or demographic information that may be pre-defined by the subscriber (if any) within the OSS/BSS system. Such information may include, for example, age information, income information or any other information that a service or content provider may have mined for the subscriber or, in some instances, that the subscriber may have self-provided. Self-provided subscriber information may include information such as, for example, a subscriber “profile,” subscriber “likes,” interests, hobbies or other self-provided subscriber information that may be provided to one or more social media content and/or application providers. The content and/or application providers can be associated with a service provider or may merely make such information available to a service provider.

Once registered within the system 10, subsequent mobility events for the subscriber may be maintained in a stateful manner, correlating the context of subscriber mobility events in to, across and/or out of one or more advertising domains. A subscriber may be registered and associated with one or more advertising domains based on the subscriber's location with respect to one or more ad domains. In one instance, a subscriber's location may be determined from mobility event messages. In another instance, a subscriber's location may also be determined from global positioning system (GPS) information associated with the subscriber.

Mobility event messages within the CHANGE category may result in modify-type analytical modeling functions being performed. CHANGE category mobility event messages may, for example, be associated with a subscriber transitioning between advertising domains. Recall, in various instances, advertising domains may be aligned to well-understood 3GPP domains such as cell locations, tracking areas or the like.

Thus, transitioning between cells, tracking areas, routing areas, paging areas or other network domains associated with certain advertising domains may be correlated to transitioning between the corresponding advertising domains. One or more analytic engines in the system may determine CHANGE modeling functions based on intercepting or receiving mobility event messages for a subscriber associated with the subscriber transitioning between one or more ad domains according to the subscriber's location in relation to the one or more ad domains. For CHANGE modeling functions, the analytic engine(s) may disassociate or remove a subscriber's information from one or more already-established analytical models for source advertising domains that the subscriber transitioned from and may associate or add the subscriber's information to one or more already-established analytical models target advertising domains into which the subscriber may transition.

Mobility event messages within the DELETE category may result in subtraction-type analytical modeling functions being performed. DELETE category mobility event messages may, for example, be associated with a subscriber losing coverage while in network domains associated with ad domains, transitioning to a WiFi system while in one or more ad domains and/or transitioning outside the coverage of any network domains associated with ad domains in the system. One or more analytic engine(s) in the system may determine DELETE modeling functions based on intercepting or receiving mobility event messages for a subscriber associated with the subscriber losing coverage in network domains associated with ad domains, transitioning to a WiFi system while in network domains associated with ad domains and/or transitioning outside the coverage of any network domains associated with ad domains in the system. For DELETE modeling functions, the analytic engine(s) may disassociate, subtract or remove the subscriber's information from one or more already-established analytical models for the one or more corresponding ad domains. The analytic engine(s) may also de-register the subscriber from any state information maintained for the subscriber.

Upon receipt of any CREATE, CHANGE and/or DELETE mobility event messages, analytical models associated with one or more ad domains may be re-computed by the analytic engine(s) within the system following an update of the corresponding models with demographics information for a given subscriber. Given the real-time or approximately real-time nature of the interfaces being monitored, the systems and methods described by the present disclosure may provide real-time or approximately real-time visibility to advertisers with regard the demographics of one or more advertising domains. Modeling information, including network mobility information, for various demographics can be aggregated across geospatial locations for a network (e.g., cell sites, tracking area, routing areas, paging areas, etc.) for multiple ad domains for a communication network. The aggregated modeling/mobility information may be used to build real-time demographics and/or population analytical models for use in one or more targeted advertising campaigns by one or more advertisers, service providers, media providers or the like to target advertising content to dense populations of specific demographics over mobile communication systems directly, through linear TV channels and/or through the Internet.

Additionally, calculations may be performed across multiple models (CBMs) in order for an advertiser to determine what types of advertisements to place in the system 10 (whether automated or otherwise). Key metrics can be calculated from the CBMs including “reach” and “frequency.” Reach can be defined as the number of “unique users” that can potentially be targeted by an advertising campaign. For example, if an advertiser wants to target something like “all males between 25 to 30 years in age who work in the consumer electronics industry and live in San Francisco and currently are in NYC” then the reach would be computed by taking the intersection of the associated compressed bitmaps for one or more ad domains in NYC. The reach metric may be a critical metric that could tell the advertiser that this target could potentially reach 500 or 50000 individuals.

Frequency is a metric that determines how many people were exposed to an advertising campaign after the campaign has been communicated to one or more ad domains. Frequency is an “after-the-fact” metric. Following from the reach example described above, a frequency metric could be determined after an advertising campaign for the targeted “all males between 25 to 30 years in age who work in the consumer electronics industry and live in San Francisco and currently are in NYC” by taking the intersection of the models for the time period that the advertising campaign was communicated to the one or more ad domains. The frequency metric can be used by an advertiser to re-calibrate their advertising process if there is a large disparity between reach and frequency for a particular target demographic.

Moreover, modeling/mobility information may be communicated upstream from the communication system 10 into the Internet through various IP services to one or more cloud-based modeling engines that may build or maintain one or more cloud-based real-time or approximately real-time demographics analytical models for use in targeted advertising campaigns for one or more ad domains. The modeling/mobility information can be used to drive additional advertising modeling across multiple communication networks for various service providers, media providers, content providers, application providers, combinations thereof or the like. In this manner, modeling/mobility information may be aggregated across large cross-sections of demographic and/or population information for pools of subscribers that can be targeted for advertising campaigns for certain advertising content. Thus, CPM may be increased by modeling mobility information that may be readily available to communication network elements.

Returning to FIG. 1, UE 12a-c can be associated with clients or customers wishing to initiate a flow in communication system 10 via some network. The terms ‘user equipment’, ‘mobile node’, ‘end user’, ‘and ‘subscriber’ are inclusive of devices used to initiate a communication, such as a computer, a personal digital assistant (PDA), a laptop or electronic notebook, a cellular telephone, an i-Phone, i-Pad, a Google Droid phone, an IP phone, or any other device, component, element, or object capable of initiating voice, audio, video, media, or data exchanges within communication system 10. UE 12a-c may also be inclusive of a suitable interface to the human user such as a microphone, a display, a keyboard, or other terminal equipment.

UE 12a-c may also be any device that seeks to initiate a communication on behalf of another entity or element such as a program, a database, or any other component, device, element, or object capable of initiating an exchange within communication system 10. Data, as used herein in this document, refers to any type of numeric, voice, video, media, or script data, or any type of source or object code, or any other suitable information in any appropriate format that may be communicated from one point to another. In certain embodiments, UE 12a-c have a bundled subscription for network access and application services (e.g., voice), etc. Once the access session is established, the user can register for application services as well, without additional authentication requirements. There can be two different user data repositories (AAA databases): one for the access user profile and one for the application user profile. IP addresses can be assigned using dynamic host configuration protocol (DHCP), Stateless Address Auto-configuration, default bearer activation, etc., or any suitable variation thereof.

PCRF 36 is a network element responsible for coordinating policy control and/or charging activities for UEs 12a-c based on various Policy Charging and Control (PCC) rules. The PCRF can be configured to use user subscription information as a basis for the policy and charging control decisions. The subscription information may apply for both session-based and non-session based services. Additionally, the PCRF may determine PCC rules based on an application or service described to the PCRF from an application function (AF). The AF may describe applications/services to the PCRF that may require policy and/or charging control for one or more UE. The policy and/or charging controls may include, but not be limited to, controlling the detection for service data flows, setting charging instructions for service data flows, setting QoS levels for service data flows and/or gating. The PCRF may communicate the PCC rules to the PCEF in the PGW. The PGW/PCEF may serve as the policy enforcement point to manage QoS, online/offline flow-based charging, data generation, deep-packet inspection and/or lawful intercept.

HSS 18 offers a subscriber database in 3GPP (e.g., GSM, LTE, etc.) environments. In one sense, HSS 18 can provide functions similar to those offered by an AAA element server in a CDMA environment. When a user moves to 3GPP access, HSS 18 can be aware of this location and this anchor point (i.e., PGW 14). Additionally, HSS 18 can communicate with AAA element 24 such that when a UE moves to a CDMA environment, it still has an effective anchor for communications (i.e., PGW 14). HSS 18 and AAA element 24 can coordinate this state information for the UE (and synchronize this information) to achieve mobility. No matter how a UE moves, the access network element can be interacting with either HSS 18 or AAA element 24 in order to identify which PGW should receive the appropriate signaling. The route to a UE can be consistently maintained, where routing topology ensures that data is sent to the correct IP address. Thus, synchronization activity on the backend of the architecture allows mobility to be achieved for the user when operating in different environments. Additionally, in certain examples, PGW 14 performs home agent functions, and the trusted non-3GPP IP access network can provide packet data serving node (PDSN) functions in order to achieve these objectives.

EIR 19 is a network element that stores a database of IMEI numbers of UE that have been reported lost or stolen. IMEI numbers are typically used by a GSM network to identify valid devices that can be used with the network. The EIR 19 can be used by network operators to disable network access for blacklisted UE that have been reported stolen or lost.

AAA element 24 is a network element responsible for accounting, authorization and authentication functions for UEs 12a-c. For the AAA considerations, AAA element 24 may provide a mobile node IP address and the accounting session identification (Acct-Session-ID) and other mobile node states in appropriate messaging (e.g., via an access-Request/access Accept message). An accounting message can be sent for the following events: accounting-start when the IP session is initially created for the mobile node on the gateway; accounting-interim-update when a handover occurred between gateways; and an accounting-stop when the IP session is removed from the gateway serving the element. For roaming scenarios, the home routed case is fully supported by the architecture.

The EPC generally comprises an MME, an SGW, a PGW (which may include a PCEF) and a PCRF. The EPC components may be referred to generally as control nodes, control gateways or simply gateways. The gateways may be used to provide various UE services and/or functions and to implement QoS on packet flows. The services and functions may be used, for example, to provision voice over IP (VoIP) routing, enhanced services such as enhanced charging, stateful firewalls and/or traffic performance optimization (TPO). The MME is the primary control element for the EPC. Among other things, the MME may provide for UE tracking and paging procedures including, for example, retransmissions, tracking area list management, idle mode UE tracking, etc. The MME may further provide for UE bearer procedures including activation, deactivation and modification; SGW and PGW selection for UE and authentication services. The SGW is a data plane element that can manage user mobility and interfaces with RANs. The SGW also maintains data paths between eNodeBs and the PGW. The PGW provides connectivity for LIES to external packet data networks, such as, for example an IP connectivity access network (IP-CAN).

The communication system 10 may include a serving general packet radio service (GPRS) support node (SGSN) 32, which may provide access for legacy universal mobile telecommunications systems (UMTS) network devices. For example, the GERAN can communicate through the SGSN 32 to the SGW 28 or the PGW 14, which can include a gateway GPRS support node (GGSN) to support communication with legacy systems. One or more nodeBs (NBs) may be used to provide mobile coverage for such legacy systems.

In an embodiment, the operational functionality and services provided by SGW 28 and PGW 14 can be combined into a system architecture evolution gateway (SAE GW) (not shown), which can support combined SGW and PGW interfaces, signaling operations, functionality, services, etc. It is understood that the embodiments, process flows and use cases discussed in the present disclosure may be equally applied to communication networks that include an SAE GW.

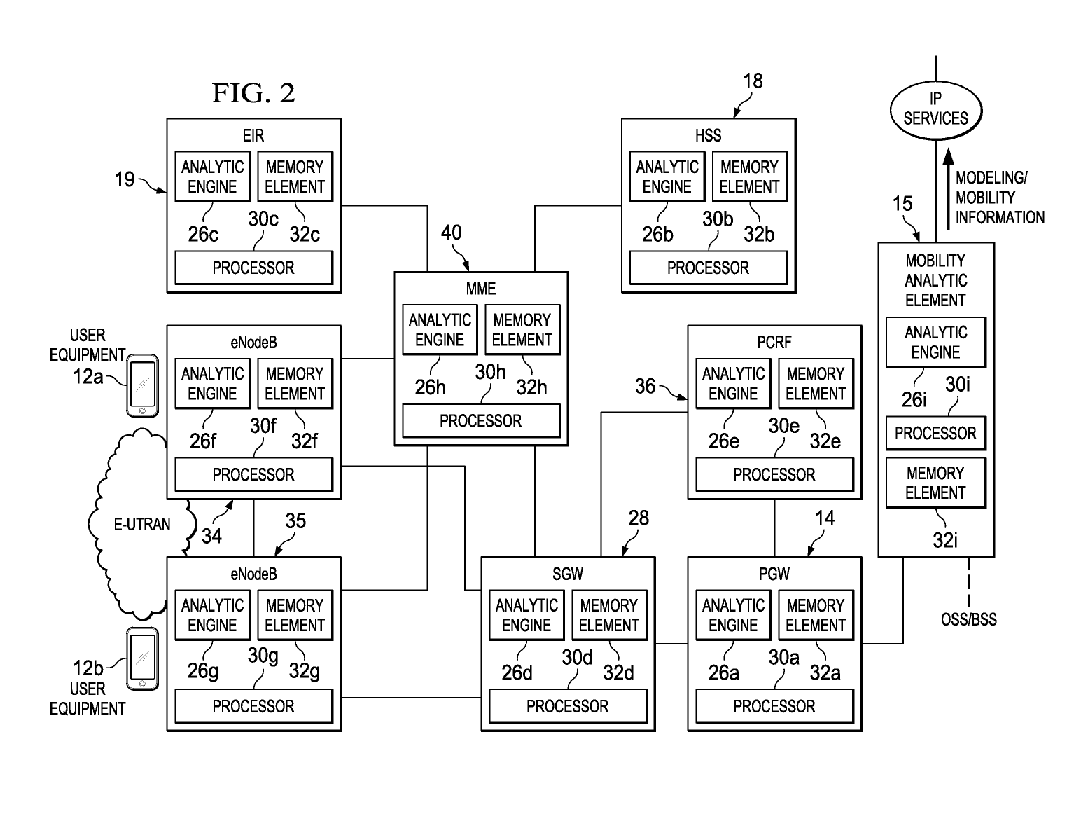

Turning to FIG. 2, FIG. 2 is a simplified block diagram illustrating additional details associated with one potential embodiment of communication system 10. FIG. 2 includes PGW 14, HSS 18, EIR 19, SGW 28, PCRF 36, first eNodeB 34, second eNodeB 35, MME 40 and MAE 15 of communication system 10. Each of these elements includes a respective processor 30a-30i and a respective memory element 32a-32i. Each of these elements further includes a respective analytic engine 26a-26i. Each analytic engine 26a-26i may be used to monitor, receive, intercept or snoop certain mobility event messages for subscribers within the system 10 and to update or maintain one or more demographic and/or population analytical models for one or more ad domains having geophysical overlays applied thereto.

Hence, appropriate software and/or hardware is being provisioned in PGW 14, MAE 15, HSS 18, EIR 19, SGW 28, first eNodeB 34, second eNodeB 35, PCRF 36 and MME 40 in order to facilitate mobility analytic operations including monitoring, receiving, intercepting or snooping certain mobility event messages and updating or maintaining one or more demographic and/or population analytical models for one or more ad domains having geophysical overlays applied thereto. Further, appropriate software and/or hardware is being provisioned in PGW 14, MAE 15, HSS 18, EIR 19, SGW 28, first eNodeB 34, second eNodeB 35, PCRF 36 and MME 40 in order to facilitate communication of OSS/BSS information throughout the system 10. Such communications may include, for example, a publish/subscribe (Pub/Sub) model in which the system 10 publishes such information for its subscribers or a “pull” model in which analytic engines 26a-26i request such information from one or more network elements.

As noted, mobility analytics may be performed across the entire 3GPP communication domain. For example, analytical modeling based on mobility events for one or more subscribers and/or state validation for one or subscriber locations in relation to one or more ad domains may be performed through one or more analytic engines provisioned in the system. Mobility analytics may be performed in-band, for example, on an interface, or out-of-band, for example, off an interface for one or more elements, nodes, gateways or the like within the system 10 depending on use case. A single instance of any of analytic engine 26a-26i may be provisioned in a given network scenario—either in-band or out-of-band—or multiple instances of the engine may be provisioned based on a particular use case. FIG. 2 illustrates out-of-band analytics engines 26a-26h and in-band analytics engine 26i. Other example provisioning alternatives are described herein below. Different provisioning alternatives may be based on particular operator constraints, particular networking environments, or specific protocol parameters.

For example, in one instance a network may include a single augmented analytic engine 26a in PGW 14. Mobility analytics may be performed by the analytic engine 26a in PGW 14, for example, by retrieving state information for one or more subscribers from certain databases and/or memory elements of SGW 28, MME 40, PCRF 36 and/or HSS 18. The state information may be used by PGW 14 to perform mobility analytics and/or to validate state information for respective locations of one or more subscribers that may be used in the analytical modeling. Similar mobility analytics and/or state validation may be performed by analytic engine 26d in SGW 28, analytic engine 26h in MME 40, analytic engine 26e in PCRF 36, analytic engine 26c in EIR 19 and/or analytic engine 26b in HSS 18. Depending on use case, an analytic engine may be augmented in a single network element or gateways or an analytic engine may be augmented in multiple network elements or gateways.

In another instance, a single analytic engine 26h augmented in MME 40. Mobility analytics may be performed by the analytic engine 26h to intercept, monitor or receive mobility event messages for the S1-CP, s13 and/or s6a interfaces for subscribers and to update one or more demographics analytical models based on the mobile event messages and subscriber information, including demographic information, for subscribers. The analytic engine 26h may recalculate one or more demographics models as they may be updated with subscriber demographics information. Depending on use case, an analytic engine may be augmented in a single network elements or gateways or an analytic engine may be augmented in multiple network elements or gateways for the system. For example, similar mobility analytics may be performed using analytic engine 26b for HSS 18 (for the s6a interface), analytic engine 26f for first eNodeB 34 (for the S1-CP and/or X2-CP interfaces) and/or analytic engine 26g for second eNodeB (for the S1-CP and/or X2-CP interfaces).

Thus, it is understood that any combination of a single analytic engine or multiple analytic engines may be provisioned in communication system 10. Note that in certain examples, certain databases can be consolidated with memory elements (or vice versa), or the storage can overlap/exist in any other suitable manner. Also depicted in FIG. 2 is UE 12a-b, where these devices can attach to the E-UTRAN network to conduct their respective communication sessions.

In one example implementation, PGW 14, MAE, HSS 18, EIR 19, SGW 28, first eNodeB 34, second eNodeB 35 and/or MME 40 are network elements, which are meant to encompass network appliances, servers, routers, switches, gateways, bridges, loadbalancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

In regards to the internal structure associated with communication system 10, each of PGW 14, MAE 15, HSS 18, EIR 19, SGW 28, first eNodeB 34, second eNodeB 35, PCRF 36 and/or MME 40 can include memory elements (as shown in FIG. 2) for storing information to be used in using network mobility events to build real-time advertising demographic and/or population maps, as outlined herein. Additionally, each of these devices may include a processor that can execute software or an algorithm to perform the activities associated with using network mobility events to build real-time advertising demographic and/or population models as discussed herein. These devices may further keep information in any suitable memory element [(e.g., random access memory (RAM), read only memory (ROM), an erasable programmable read only memory (EPROM), application specific integrated circuit (ASIC), etc.], software, hardware, or in any other suitable component, device, element, or object where appropriate and based on particular needs. Any of the memory items discussed herein should be construed as being encompassed within the broad term ‘memory element.’ The information being tracked, monitored, intercepted, received, snooped, modeled, sent, reported and/or communicated by PGW 14, MAE 15, HSS 18, EIR 19, SGW 28, first eNodeB 34, second eNodeB 35 PCRF 36 and/or MME 40 could be provided in any database, queue, register, control list, or storage structure, all of which can be referenced at any suitable timeframe. Any such storage options may be included within the broad term ‘memory element’ as used herein. Similarly, any of the potential processing elements, modules, and machines described herein should be construed as being encompassed within the broad term ‘processor.’ Each of the network elements and user equipment (e.g., mobile nodes) can also include suitable interfaces for receiving, transmitting, and/or otherwise communicating data or information in a network environment.

In one example implementation, PGW 14, MAE 15, HSS 18, EIR 19, SGW 28, first eNodeB 34, second eNodeB 35, PCRF 36 and/or MME 40 include software (e.g., as part analytic engines 26a-26i, etc.) to achieve, or to foster, the mobility analytic operations and/or modeling as outlined herein. In other embodiments, these features may be provided externally to these elements, or included in some other network device to achieve this intended functionality. Alternatively, the elements may include software (or reciprocating software) that can coordinate in order to achieve the operations, as outlined herein. In still other embodiments, one or all of these devices and/or elements may include any suitable algorithms, hardware, software, components, modules, interfaces, or objects that facilitate the operations thereof.

Note that in certain example implementations, the functions for using network mobility events to build or maintain real-time or approximately real-time advertising demographics as outlined herein may be implemented by logic encoded in one or more tangible media, which may be inclusive of non-transitory media (e.g., embedded logic provided in an ASIC, in DSP instructions, software [potentially inclusive of object code and source code] to be executed by a processor, or other similar machine, etc.). In some of these instances, memory elements [as shown in FIG. 2] can store data used for the operations described herein. This includes the memory elements being able to store software, logic, code, or processor instructions that are executed to carry out the activities described herein. A processor can execute any type of instructions associated with the data to achieve the operations detailed herein. In one example, the processors [as shown in FIG. 2] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a digital signal processor (DSP), an EPROM, EEPROM) or an ASIC that includes digital logic, software, code, electronic instructions, or any suitable combination thereof.

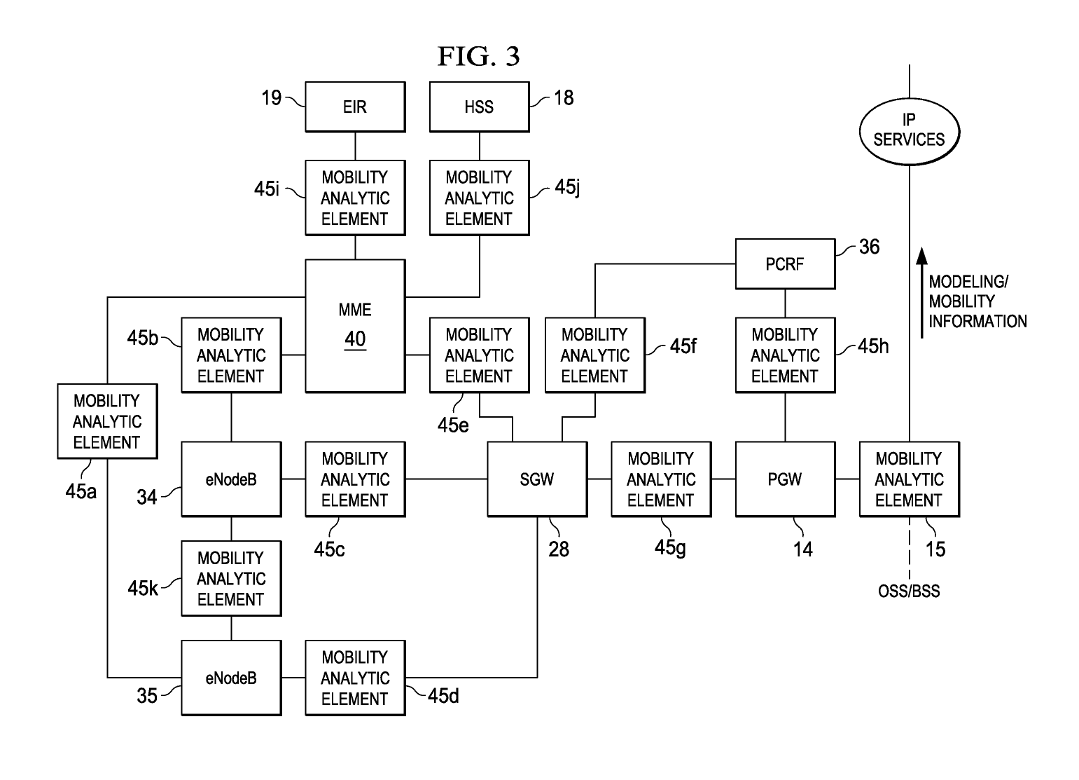

Turning to FIG. 3, FIG. 3 is simplified block diagram illustrating other example details associated with one potential embodiment of the communication system 10. FIG. 3 includes PGW 14, MAE 15, HSS 18, EIR 19, SGW 28, first eNodeB 34, second eNodeB 35, PCRF 36 and MME 40 of communication system 10 and further illustrates additional in-band mobility analytic elements 45a-45j. FIG. 3 is provided to illustrate example implementations for provisioning the system 10 with in-band MAEs. For example, MAE 45a may be provisioned on the interface between the MME 40 and eNodeB 35; MAE 45b may be provisioned on the interface between MME 40 and first eNodeB 34; MAE 45c may be provisioned on the interface between first eNodeB 34 and SGW 28; MAE 45d may be provisioned on the interface between second eNodeB 35 and SGW 28; MAE 45e may be provisioned on the interface between MME 40 and SGW 28; MAE 45f may be provisioned on the interface between PCRF 36 and SGW 28; MAE 45g may be provisioned on the interface between SGW 28 and PGW 14; MAE 45h may be provisioned on the interface between PCRF 36 and PGW 14; MAE 45i may be provisioned between EIR 19 and MME 40; MAE 45j may be provisioned on the interface between HSS 18 and MME 40 and/or MAE 45k may be provisioned between on the interface between first eNodeB 34 and second eNodeB 35.

Each MAE 45a-45k shown in FIG. 3 may include respective analytic engines, processors and memory elements as shown and described above for MAE 15 in FIG. 2. A single instance of an in-band MAE and a corresponding analytic engine or multiple instances of in-band MAEs including corresponding analytic engines may be provisioned in the system 10, depending on use case. Corresponding analytic engines in each of MAE 45a-45k and MAE 15 may be used to snoop, monitor, intercept or receive mobility event messages for one or more subscribers in one or more ad domains for communication system 10. Based on the mobility event messages and the locations of one or more subscribers in relation to one or more advertising domains, the analytic engines in MAE 45a-45K and MAE 15 may perform analytical modeling updates for one or more subscribers for one or more ad domains having geophysical overlays applied thereto and/or may perform state validation for one or subscriber locations in relation to one or more ad domains for the system 10.

Hence, appropriate software and/or hardware is being provisioned in MAEs 45a-45k and corresponding analytic engines within the MAEs to facilitate mobility analytic operations including monitoring, receiving, intercepting or snooping certain mobility event messages, updating or maintaining one or more analytical models for one or more ad domains and/or validating subscriber location information in relation to one or more ad domains for the system 10. Further, appropriate software and/or hardware is being provisioned in MAEs 45a-45k and corresponding analytic engines to facilitate communication of OSS/BSS information throughout the system 10 such as, for example, through a Pub/Sub model or a Pull model for obtaining such information. The MAEs 45a-45k and corresponding analytic engines may include software, hardware and other elements as described above for MAE 15 and corresponding analytic engines.

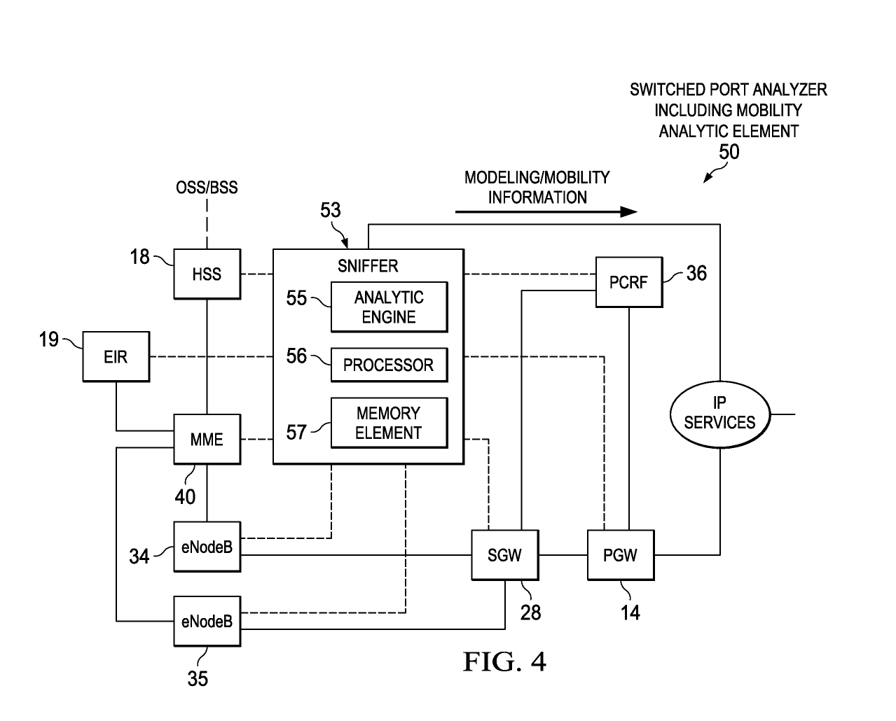

Turning to FIG. 4, FIG. 4 is a simplified block diagram illustrating details associated with one example use case 50 of the communication system 10 including a port sniffer 53 provisioned with an analytic engine 55. FIG. 4 includes PGW 14, HSS 18, EIR 19, SGW 28, first eNodeB 34, eNodeB 35, PCRF 36 and MME 40 of communication system 10. Port sniffer 53 may interface to a switched port analyzer (SPAN) port for each these network elements. The SPAN port for each network element may be configured to receive a copy of certain traffic routed to/from each of these network elements. For example, certain mobility event traffic for certain mobility event messages as noted above and/or other traffic related to mobility events for subscribers within the system 10 may be copied or replicated to SPAN ports for each of the PGW, HSS 18, EIR 19, SGW 28, first eNodeB 34, second eNodeB 35 interfacing with port sniffer 53.

Port sniffer 53 may further include a processor 56 and a memory element 57. Analytic engine 55 may monitor network mobility events for one or more subscribers in order to build or maintain one or more demographic and/or population analytical models for one or more ad domains having geophysical overlays applied thereto. Hence, appropriate software and/or hardware is being provisioned in port sniffer 53 in order to facilitate mobility analytic operations including receiving or monitoring certain mobility event messages from the network elements and updating or maintaining one or more demographic and/or population analytical models for one or more ad domains having geophysical overlays applied thereto. Further, appropriate software and/or hardware is provisioned in port sniffer 53 in order to receive OSS/BSS information from one or more elements within the system 10.

Processor 56 included in port sniffer 53 can execute software or an algorithm to perform the activities associated with using network mobility events to build real-time advertising demographic and/or population maps as discussed herein. Port sniffer 53 may further keep information in any suitable memory element [e.g., random access memory (RAM), read only memory (ROM), an erasable programmable read only memory (EPROM), application specific integrated circuit (ASIC), etc.], software, hardware, or in any other suitable component, device, element, or object where appropriate and based on particular needs. Any of the memory items discussed herein should be construed as being encompassed within the broad term ‘memory element.’ The information being tracked, monitored, received, intercepted, snooped, modeled, sent, reported or communicated by port sniffer 53 and analytic engine 55 could be provided in any database, queue, register, control list, or storage structure, all of which can be referenced at any suitable timeframe. Any such storage options may be included within the broad term ‘memory element’ as used herein. Port sniffer 53 can also include suitable interfaces for receiving, transmitting, and/or otherwise communicating data or information in a network environment.

One of the more important analytical models for advertisers in the process of creating campaigns is the number of possible unique users that a given campaign may target—although it may not necessary to know which specific users the campaign will actually target. For example, if an advertiser is trying target “small business owners who live in Boston and are over 55” then they need to know if that pool through the inventory available in a given channel will target 500 people, 5000 people or 50000 people. Such modeling can be achieved by using the “unique user” metric obtained through monitoring subscriber mobility events and applying such user events to past data in order to build easily composable models for one or more ad domains. Similarly, after a campaign is over an advertiser will want to know how many actual users they were successful in targeting. These metrics can be accomplished using CBM analytical models, which may include network mobility information aggregated across geospatial locations for a network (e.g., cell sites, tracking area, routing areas, etc.) for one or more ad domains. Aggregated modeling information, including network mobility information, may be used to build real-time demographics and/or population analytical models for use in one or more targeted advertising campaigns by one or more advertisers, service providers, media providers or the like to target advertising content to dense populations of specific demographics over mobile communication systems directly, through linear TV channels and/or through the Internet.

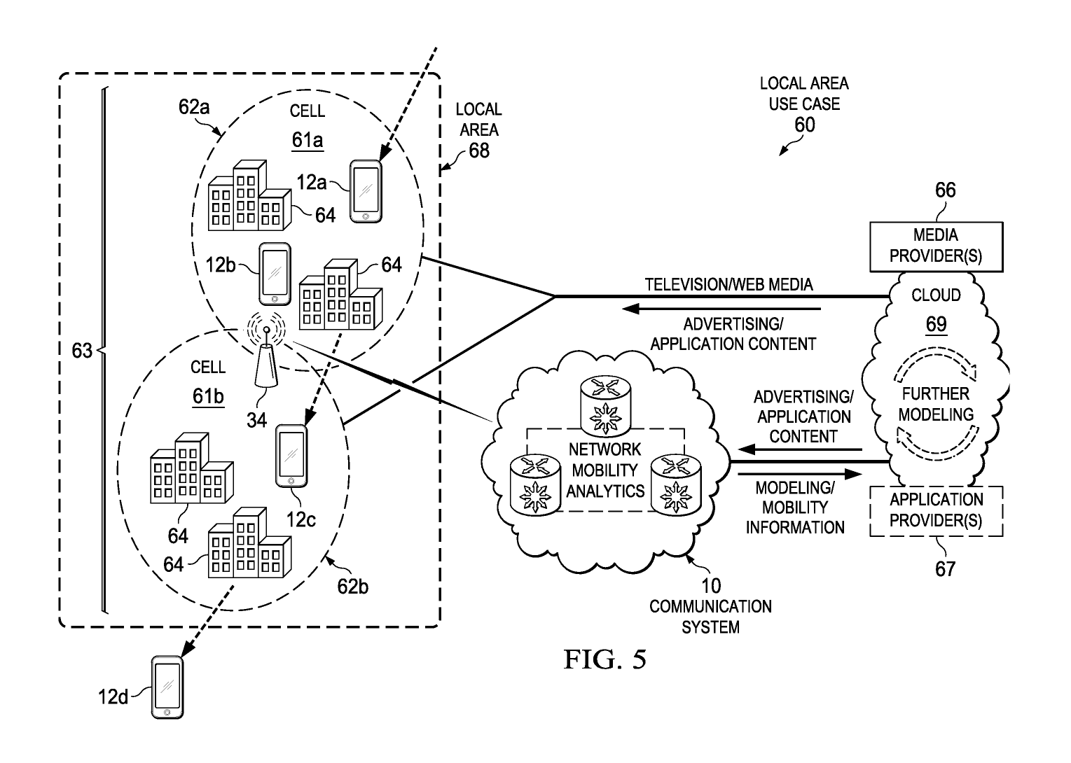

Turning to FIG. 5, FIG. 5 is a simplified block diagram illustrating details associated with an example use case 60 in which network mobility events and corresponding analytical modeling/mobility information for subscribers associated with UE 12a-d can be aggregated across a local area 68 including cells 61a-b. Coverage for cells 61a-b may be provided by first eNB 34. As illustrated in FIG. 5, each of an ad domain 62a-b may be associated with each corresponding cell 61a-b and another ad domain 63 may be associated with both cells 61a-b. It is understood that the ad domains shown in FIG. 5 are provided for illustrative purposes only and ad domains for the communication system 10 may include any combination of network domains, including but not limited to, one or more cells, one or more tracking areas, one or more routing areas, one or more paging areas, combinations thereof or the like.

FIG. 5 includes communication system 10, which may include one or more analytic engine(s) provisioned in the system, either within one or more MAEs, port sniffers and/or other nodes/elements/gateways in any configuration, depending on use case, as described above in FIGS. 1-4, for performing network mobility analytics as described throughout the present disclosure, however, the one or more analytic engine(s) are not shown in FIG. 5 in order to illustrate other features of use case 60. Communication system 10 may include the PGW, HSS, EIR, SGW, PCRF, MME 40 and/or port sniffer, depending on use case, as shown in FIGS. 1-4; however these network nodes/elements/gateways are not shown in FIG. 5 in order to illustrate other features of use case 60. Communication system 10 may be coupled to the Internet through one or more IP services, which may connect the system 10 to a cloud 69. One or more media provider(s) 66 may be connected to the cloud 69. In some embodiments, one or more application provider(s) 67 may also be connected to the cloud 69.

Further shown in FIG. 5, one or more geographic mapping element(s) 64 may be overlaid, mapped or indexed to one or more demographic and/or population analytical models that may be built or maintained using one or more analytic engine(s) within communications system 10 for the ad domains and associated network domains/locations. Geographic mapping elements 64 may be retrieved for one or more mapping APIs. In various embodiments, mapping elements 64 may correspond to businesses or other retail establishments, schools, places of employment, residential dwellings, roads, highways, mass transit routes combinations thereof or the like. Generally, any location, which may be obtained from one or more publicly available mapping APIs may be indexed to one or more demographics analytical models using one or more CBM custom aggregate models for ad/network domains. Further, one or more DMAs may be overlaid, mapped or indexed to one or more demographic and/or population analytical models that may be build or maintained for the ad domains and associated network domains/locations.

The analytic engine(s) within communication system 10 may monitor, intercept, snoop or receive mobility event messages for LIE 12a-d and, based on the messages and location UE 12a-d, may operate to perform a set of modeling functions using demographic information for subscribers associated with UE 12a-d for one or more demographics analytical models for ad domains 62a-b and 63 to compute real-time or approximately real-time advertising demographics for the local area 68. Subscriber information, including demographic information, for users associated with UE12a-c may be obtained through one or more OSS/855 systems for one or more service providers that may be associated with communication system 10. In various embodiments, location information for UE 12a-c in relation to one or more ad domains may be determined from network mobility event messages received from UE 12a-c or may be determined from GPS information associated with UE 12a-c that may be received from the UE. The analytic engine(s) may update one or more already-established analytical models using subscriber information, including any demographic information for a subscriber that may be available to the analytic engine(s), for ad domains and/or locations within the ad domains as mapped to corresponding CBM location indexes for the demographics analytical models.

As shown in FIG. 5, LIE 12a is transitioning into the coverage of cell 61a. Based on transitioning into cell 61a, one or more mobility event messages may be received by one or more analytic engine(s) in communication system 10. As noted, cell 61a is associated with ad domains 62a and 63. Based on UE 12a transitioning into cell 61a and corresponding ad domains 62a and 63, one or more analytic engine(s) within the system 10 may determine a CREATE modeling function from the location change of UE 12a in relation to the ad domains. The analytic engine(s) can determine user subscription information and/or demographic information for a subscriber associated with UE 12a based on a correlation between a mobile subscriber ID for UE 12a (e.g., IMSI, IMSI, IMEI, IMEISV) with information stored in one or more OSS/BSS systems for the particular subscriber. The analytic engine(s) may also register location information of UE 12a in relation to ad domains 62a and 63 in order to maintain state information for UE 12a.

Based on the determination of a CREATE modeling function, the subscriber information, including demographic information for the subscriber associated with UE 12a may be added to and/or associated with one or more already-established analytical models associated with ad domains 62a and 63. The demographics analytical models associated with these ad domains may be re-computed by the analytic engine(s) to extract certain pre-determined demographic and/or population information from the models for a plurality of subscribers that may be in the ad domains.

As noted, monitoring network mobility events for subscribers in ad domains can be used to determine real-time or approximately real-time information for subscribers. This can include dwell time for a subscriber within one or more ad domains at corresponding locations within the ad domains. Dwell time for subscribers may be learned through mobility event messages associated with location reporting procedures such as LOCATION REPORTING CONTROL and LOCATION REPORT. As shown in FIG. 5, UE 12b is in ad domain 62a and 63 and is currently located near one of the mapping elements in these ad domains. Based on intercepting or monitoring mobility event messages for UE 12b by one or more analytic engine(s) in communication, the analytic engine(s) may determine dwell time information for a subscriber associated with UE 12b within ad domains 62a and 63. The dwell time information may be used to model additional demographic information for the user associated with UE 12b.

Also shown in FIG. 5, UE 12c is transitioning from cell 61a (associated with ad domain 62a) into the coverage of cell 61b. Based on transitioning into cell 61b, one or more mobility event messages may be received by one or more analytic engine(s) in communication system 10. As noted, cell 61b is associated with ad domains 62b and 63. Based on UE 12c transitioning into cell 61b and corresponding ad domain 62b from cell 61a and corresponding ad domain 61a, one or more analytic engine(s) within the system 10 may determine a CHANGE modeling function from the location change for LIE 12c in relation to the ad domains. The analytic engine(s) can determine user subscription information and/or demographic information for a subscriber associated with UE 12c based on a correlation between a mobile subscriber ID for UE 12c with information stored in one or more OSS/BSS systems for the particular subscriber. The analytic engine(s) may update location information of UE 12c in relation to ad domains 62a and 62b in order to maintain state information for UE 12c.

Based on the determination of the CHANGE modeling function, the subscriber information, including demographic information for the subscriber associated with UE 12c may be added to and/or associated with one or more already-established analytical models associated with ad domain 62b, and the information associated with the subscriber may be removed from and/or disassociated with one or more already-established analytical models associated with ad domain 62a. One or more demographics analytical models associated with these domains may be re-computed by the analytic engine(s) to extract certain pre-determined demographic and/or population information from the models for a plurality of subscribers that may be in the ad domains. In an embodiment, the analytic engine(s) can also update dwell time information for UE 12c in relation to ad domain 63, as the transition for UE 12c may not result in a CREATE, CHANGE or DELETE modeling event for the subscriber with respect to analytic models associated with ad domain 63.

Further shown in FIG. 5, UE 12d is transitioning from cell 61b (associated with ad domain 62b) to an area outside the coverage of cell 61b. Based on transitioning out of the coverage of cell 61b, one or more mobility event messages may be received by one or more analytic engine(s) in communication system 10. As noted, cell 61b is associated with ad domains 62a and 63. Based on UE 12d transitioning out of the coverage of cell 61b and corresponding ad domains 62b and 63, one or more analytic engine(s) within the system 10 may determine a DELETE modeling function from the location change of UE 12d in relation to the ad domains. The analytic engine(s) can determine user subscription information and/or demographic information based on a correlation between the ID for UE 12d with information stored in one or more OSS/BSS systems. The analytic engine(s) may de-register any location state information maintained for UE 12d.

Based on the determination of the DELETE modeling function, subscriber information, including demographic information for the subscriber associated with UE 12d may be removed from and/or disassociated with one or more already-established analytical models associated with ad domains 62b and 63.

One or more demographics analytical models associated with these domains may be re-computed by the analytic engine(s) to extract certain pre-determined demographic and/or population information from the models for a plurality of subscribers that may be in the ad domains. Additionally, certain metrics may be calculated for the models. For example, a reach metric can be calculated as an intersection across multiple models in order to determine a potential number of subscribers for a particular demographic that may be exposed to a particular campaign targeted to the demographic. Further, a frequency metric can be calculated following the communication of one or more advertising campaigns targeted to the demographic.

Thus, as shown in use case 60 illustrated in FIG. 5, network mobility events monitored, intercepted, received or snooped on LTE networks can be used to build real-time geo-location maps of subscribers based on demographics that can be segmented into “communications areas,” e.g., the cell towers that can be used to reach the demographics. The one or more analytic engine(s) within the system 10 may communicate modeling/mobility information to the cloud 69. The modeling/mobility information may include demographic and/or population information for ad domains 62a-b and 63, which can include demographic information for subscribers associated with UE 12a-c. Modeling/mobility information including demographic information for the subscriber associated with UE 12d may or may not be communicated to the cloud 69 depending of course on the time(s) that modeling/mobility information may be communicated to the cloud. Further demographic and/or population modeling may be performed in the cloud 69 using the modeling/mobility information communicated to the cloud from the one or more analytic engine(s) within communication system 10. The cloud-based modeling may be used to identify and/or aggregate additional information together with the modeling/mobility information from communication system 10 for use in one or more targeted advertising campaigns for ad domains 62a-b and/or 63 for media provider(s) 66. In various embodiments, the additional cloud information may include modeling/mobility information aggregated from other communication systems. Such embodiments are described in further detail below. Advertising content may be communicated to users in ad domains 62a-b and/or 63 through linear television, web media outlets and/or back through the communication system 10 as shown in FIG. 5.

In some embodiments, network mobility information may be reported from one or more analytic engine(s) in the system 10 to one or more application provider(s) 67 through the Internet and/or cloud. One or more corresponding applications may be provisioned on UE 12a-d that may be provided and/or developed by the one or more application provider(s) 67. Various types of mobility information may be reported to application provider(s) 67 for UE 12a-d based on mobility event messages monitored, received or intercepted for the UE by one or more analytic engine(s) in the communication system 10. The types of information may include, but not be limited to, non-anonymous mobility information for a single UE (e.g., including subscriber information associated with the UE), anonymous mobility information for a single UE, non-anonymous mobility information for a group of LIE (e.g., a group of UE that meet a certain profile), anonymous mobility information for a group of UE, non-anonymous mobility information for all UE tracked by the system and/or anonymous mobility information for all UE tracked by the system. Demographics can be ascertained from OSS/BSS systems and classified anonymously.

In various embodiments, the mobility information for UE may be used by application provider(s) 67 in order to, for example, target advertising content to certain/all subscribers associated with the UE, target application content offerings to certain/all subscribers associated with the UE, target additional application offerings to certain/all subscribers associated with the UE and/or learn behavior information, such as potential interests, lifestyle, employment, leisure or other information about the subscribers.

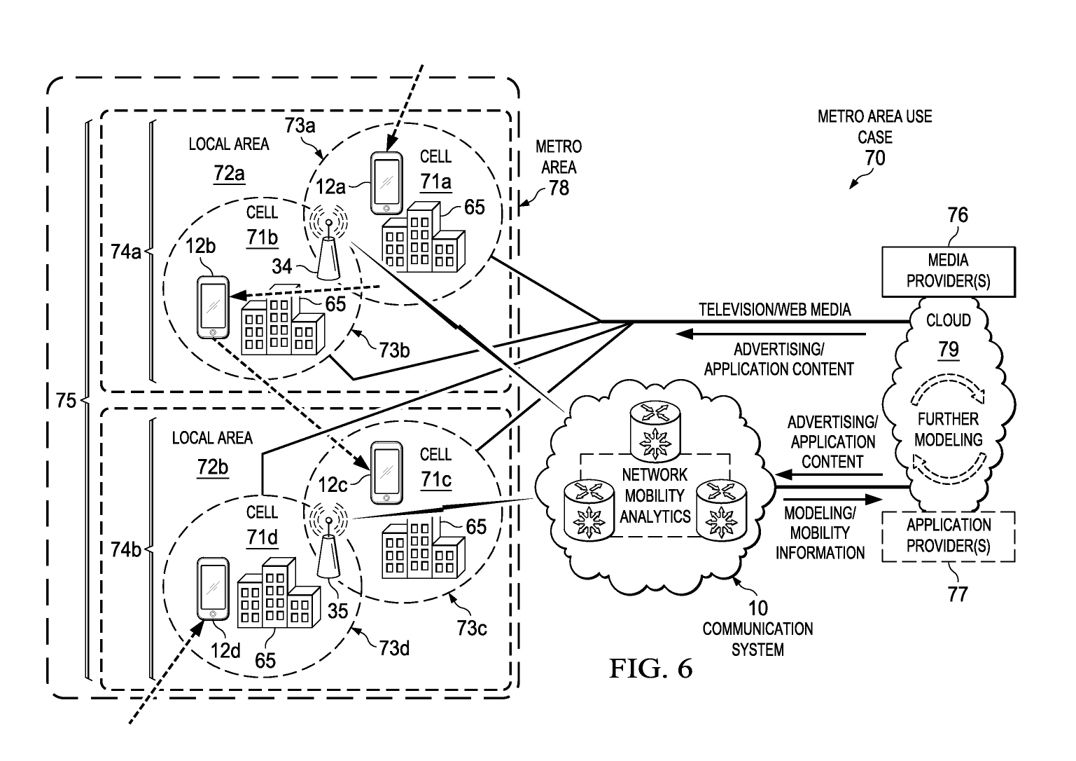

Modeling information including network mobility information may be aggregated across any network domain area for one or more ad domains. Turning to FIG. 6, FIG. 6 is a simplified block diagram illustrating details associated with another example use case 70 in which network mobility events and corresponding analytical modeling information can be aggregated across a metro area 78 including cells 71a-d for subscribers associated with UE 12a-d. Coverage for cells 71a-b may be provided by first eNB 34 for a local area 72a and coverage for cells 71c-d may be provided by second eNB 35 for another local area 72b. Thus, targeted advertising for the metro area 78 may targeted for pools of subscribers across both local areas 72a-b.

As illustrated in FIG. 6, each ad domain 73a-d may be associated with each corresponding cell 71a-d; an ad domain 74a may be associated with both of cells 71a and 71b; an ad domain 74b may be associated with both of cells 71c and 71d; and an ad domain 75 may be associated with all the cells 71a-d. It is understood that the ad domains shown in FIG. 6 are provided for illustrative purposes only and ad domains for the communication system 10 may include any combination of network domains, including but not limited to, one or more cells, one or more tracking areas, one or more routing areas, one or more paging areas, combinations thereof or the like.

FIG. 6 includes communication system 10, which may include one or more analytic engine(s) provisioned in the system, either within one or more MAEs, port sniffers and/or other nodes/elements/gateways in any configuration, depending on use case, as described above in FIGS. 1-4, for performing network mobility analytics as described throughout the present disclosure, however, the one or more analytic engine(s) are not shown in FIG. 6 in order to illustrate other features of use case 70. Communication system 10 may include the PGW, HSS, EIR, SGW, PCRF, MME and/or port sniffer as shown in FIGS. 1-4, depending on use case; however these network nodes/elements/gateways are not shown in FIG. 6 in order to illustrate other features of use case 70. Communication system 10 may be coupled to the Internet through one or more IP services, which may connect the system 10 to a cloud 79. One or more media provider(s) 76 may be connected to the cloud 79. In some embodiments, one or more application provider(s) 77 may also be connected to the cloud 79.

Further shown in FIG. 6, one or more geographic mapping element(s) 65 may be overlaid, mapped or indexed to one or more demographics analytical models that may be built or maintained using one or more analytic engine(s) within communications system 10 for the ad domains and associated network domains/locations. Geographic mapping element(s) 65 may be retrieved for one or more mapping APIs and can correspond to various elements, as discussed above for FIG. 6. Further, one or more DMAs may be overlaid, mapped or indexed to one or more demographic and/or population analytical models that may be build or maintained for the ad domains and associated network domains/locations.

The analytic engine(s) within communication system 10 may monitor, intercept, snoop or receive mobility event messages for UE 12a-d and may operate to perform a set of modeling functions based on the messages for one or more demographics and/or population analytical models for ad domains 73a-d, 74a-b and/or 75 to compute real-time or approximately real-time advertising demographics for the metro area 78. Subscriber information, including demographic information, for users associated with UE12a-d may be obtained through one or more OSS/BSS systems for one or more service providers that may be associated with communication system 10. In various embodiments, location information for UE 12a-d in relation to the one or more ad domains may be determined from network mobility event messages received from UE 12a-d or may be determined from GPS information associated with UE 12a-d that may be received from the UE. The analytic engine(s) may update one or more already-established analytical models using subscriber information, including any demographic information for a subscriber that may be available to the analytic engine(s), for ad domains and/or locations within the ad domains as mapped to corresponding CBM location indexes for the demographics analytical models.

As shown in FIG. 6, UE 12a is transitioning into the coverage of cell 71a. Based on transitioning into cell 71a, one or more mobility event messages may be received by one or more analytic engines in communication system 10. As noted, cell 71a is associated with ad domains 73a, 74a and 75. Based on UE 12a transitioning into cell 71a and corresponding ad domains 73a, 74a and 75, one or more analytic engine(s) within the system 10 may determine a CREATE modeling function from the location change of UE 12a in relation to the ad domains. The analytic engine(s) can determine user subscription information and/or demographic information for a subscriber associated with UE 12a based on a correlation between the mobile subscriber ID for UE 12a with information stored in one or more OSS/BSS systems for the particular subscriber. The analytic engine(s) may register location information of UE 12a in relation to ad domains 73a, 74a and 75 in order to maintain state information for UE 12a.

Based on the determination of the CREATE modeling function, subscriber information, including demographic information for the subscriber associated with UE 12a may be added to and/or associated with one or more already-established analytical models associated with ad domains 73a, 74a and 75. One or more demographics analytical models associated with these ad domains may be re-computed by the analytic engine(s) to extract certain pre-determined demographic and/or population information from the models for a plurality of subscribers that may be in the ad domains.

Also shown in FIG. 6, LIE 12b is transitioning from cell 71a (associated with ad domain 63a) into the coverage of cell 71b. Based on transitioning into cell 71b, one or more mobility event messages may be received by one or more analytic engine(s) in communication system 10. As noted, cell 71b is associated with ad domains 73b, 74a and 75. Based on UE 12b transitioning into cell 71b and corresponding ad domain 73b from cell 71a and corresponding ad domain 73a, one or more analytic engine(s) within the system 10 may determine a CHANGE modeling function from the location change of UE 12b in relation to ad domains 73a and 73b. The analytic engine(s) can determine user subscription information and/or demographic information based on a correlation between the ID for UE 12b with information stored in one or more OSS/BSS systems. The analytic engine(s) may update location information of UE 12b in relation to ad domains 73a and 73b in order to maintain state information for UE 12b.

Based on the determination of the CHANGE modeling function, the subscriber's information associated with UE 12b may be added to and/or associated with one or more already-established analytical models associated with ad domain 73b, and the subscriber's information may be removed from and/or disassociated with one or more already-established analytical models associated with ad domain 73a. The analytical models may be re-computed by the analytic engine(s) to extract certain pre-determined demographic and/or population information from the models for a plurality of subscribers that may be in the ad domain. In an embodiment, the analytic engine(s) can also update dwell time information for UE 12b in relation to ad domains 74a and 75, as the transition for UE 12b may not result in a CREATE, CHANGE or DELETE modeling event for the subscriber with respect to analytic models associated with ad domains 74a and 75.

Additionally shown in FIG. 6, UE 12c is transitioning from cell 71b into the coverage of cell 71c associated with second eNB 35. Based on transitioning into cell 71c, one or more mobility event messages may be received by one or more analytic engine(s) in communication system 10. The mobility event messages may, for example, be associated with handover procedures for UE 12c between first eNB 34 and second eNB 35. As noted, cell 71c is associated with ad domains 73c, 74b and 75. Based on UE 12c transitioning into cell 71c and corresponding ad domains 73c and 74b from cell 71b and corresponding ad domains 73b and 74a, one or more analytic engine(s) within the system 10 may determine a CHANGE modeling function from the location change of UE 12b in relation to ad domains 73b, 74a, 73c and 74b. The analytic engine(s) can determine user subscription information and/or demographic information based on a correlation between the ID for UE 12c with information stored in one or more OSS/BSS systems. The analytic engine(s) may update location information of UE 12c in relation to ad domains 73b, 74a, 73c and 74b in order to maintain state information for UE 12c.

Based on the determination of the CHANGE modeling function, subscriber information, including demographic information for the subscriber associated with UE 12c may be added to and/or associated with one or more already-established analytical models associated with ad domains 73c and 74b, and the subscriber's information may be removed from and/or disassociated with one or more already-established analytical models associated with ad domains 73b and 74a. The analytical models may be re-computed by the analytic engine(s) to extract certain pre-determined demographic and/or population information from the models for a plurality of users that may be in the ad domains. In an embodiment, the analytic engine(s) can also update dwell time information for UE 12c in relation to ad domains 75, as the transition for UE 12b may not result in a CREATE, CHANGE or DELETE modeling event for the subscriber with respect to analytic models associated with ad domains 75.

Further shown in FIG. 6, UE 12d is transitioning into the coverage of cell 71d. Based on transitioning into cell 71d, one or more mobility event messages may be received by one or more analytic engines in communication system 10. As noted, cell 71d is associated with ad domains 73d, 74b and 75. Based on UE 12d transitioning into cell 71d and corresponding ad domains 73d, 74b and 75, one or more analytic engine(s) within the system 10 may determine a CREATE modeling function from the location change of UE 12d in relation to ad domains 73d, 74b and 75. The analytic engine(s) can determine user subscription information and/or demographic information for a subscriber associated with UE 12d based on a correlation between a mobile subscriber ID for UE 12d with information stored in one or more OSS/BSS systems for the particular subscriber. The analytic engine(s) may register location information of UE 12d in relation to ad domains 73d, 74b and 75 in order to maintain state information for LIE 12d.

Based on the determination of the CREATE modeling function, subscriber information, including demographic information for the subscriber associated with UE 12d may be added to and/or associated with one or more already-established analytical models associated with these domains.

The analytical models may be re-computed by the analytic engine(s) to extract certain pre-determined demographic and/or population information from the models for a plurality of subscribers that may be in the ad domains. Additionally, certain metrics may be calculated for the models. For example, a reach metric can be calculated as an intersection across multiple models in order to determine a potential number of subscribers for a particular demographic that may be exposed to a particular campaign targeted to the demographic. Further, a frequency metric can be calculated following the communication of one or more advertising campaigns targeted to the demographic.

The one or more analytic engine(s) within the system 10 may communicate modeling/mobility information to the cloud 79. The modeling/mobility information may include demographic and/or population information for ad domains 73a-d, 74a-b and 75, which can include demographic information for subscribers associated with UE 12a-d. Further demographic and/or population modeling may be performed in the cloud 79 using the modeling/mobility information communicated to the cloud from the one or more analytic engine(s) within communication system 10. The cloud-based modeling may be used to identify and/or aggregate additional information together with the modeling/mobility information from communication system 10 for use in one or more targeted advertising campaigns for ad domains 73a-d, 74a-b and/or 75 for media provider(s) 66. In various embodiments, the additional cloud information may include modeling/mobility information aggregated from other communication systems. Advertising content may be communicated to subscribers in ad domains 73a-d, 74a-b and/or 75 and/or 63 through linear television, web media outlets and/or back through the communication system 10 as shown in FIG. 6.

In some embodiments, network mobility information may be reported from one or more analytic engine(s) in the communication system 10 to one or more application provider(s) 77 through the Internet/cloud. One or more corresponding applications may be running on UE 12a-d that may be provided by the one or more application provider(s) 77. Various types of mobility information, as described above, may be reported to application provider(s) 77 for UE 12a-d based on mobility event messages monitored, received or intercepted for the UE by one or more analytic engine(s) in the communication system 10. In various embodiments, the mobility information for UE may be used by application provider(s) 77 in order to, for example, target advertising content to certain/all subscribers associated with the UE, target application content offerings to certain/all subscribers associated with the LIE, target additional application offerings to certain/all subscribers associated with the UE and/or learn behavior information, such as potential interests, lifestyle, employment, leisure or other information about the subscribers.

Thus, the use cases 60 and 70 as shown in FIGS. 5 and 6 illustrate that network mobility information may be aggregated across multiple network domains for communication system 10. Aggregation of network mobility information across multiple network domains may provide enhanced demographic and/or population modeling information for use in sophisticated ad decision engines, which may include improved logic to target dense populations of demographics either over mobile networks directly, through linear TV channels and/or through the Internet for targeted advertising campaigns and/or application content delivery, depending on use case, for media providers, advertisers, application providers, etc. The logic in such ad decision engines may include an understanding of the macro-cellular environment for one or more network domains, e.g., cell tower locations mapped to geospatial locations for one or more ad domains.

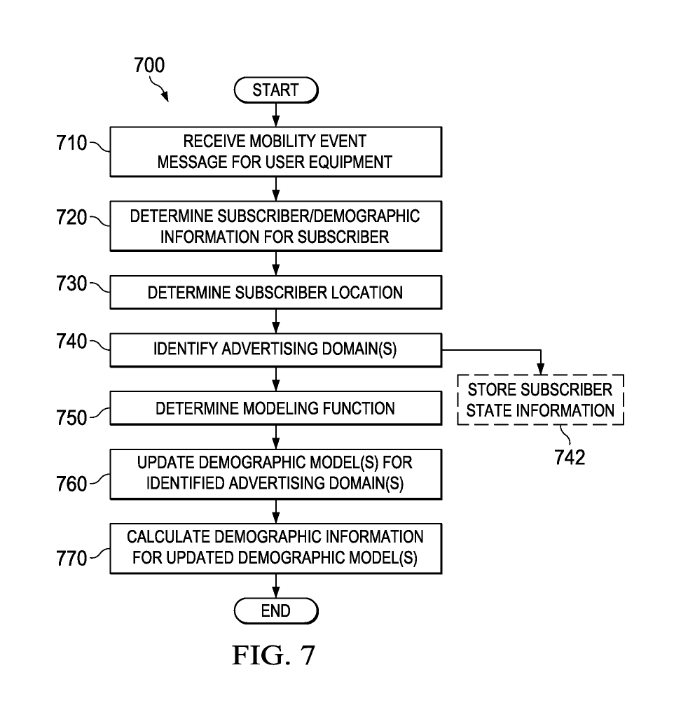

Turning to FIG. 7, FIG. 7 is a simplified flow diagram 700 illustrating example operations associated with building advertising demographics models using network mobility events according to an embodiment. In one particular embodiment, these operations may be carried out by an analytic engine, e.g., any of analytic engines 26a-26i, which may be provisioned in any of one or more MAEs, port sniffers, network nodes, elements, gateways or the like. At any time, one or more network domains may be mapped to one or more ad domains for the communication system 10. One or more analytic engines within the communication system 10 may operate to update and/or maintain one or more demographics analytical models based on certain mobility event messages that may be processed by the system. The mobility event messages may include, but not be limited to, handover messages on the S1-CP and/or X2-CP interface, location reporting procedure messages on the S1-CP interface, location management procedure messages on the s6a interface, and/or subscriber data handling procedure messages on the s6a interface.

Thus, processing starts when a mobility event message may be received for a first user equipment at 710. Demographic information for a first subscriber associated with the first user equipment may be determined based on subscription information for the first subscriber at 720. Subscription information and/or demographic information for the first subscriber associated with the first user equipment may be determined from OSS/BSS information that may be communicated to the one or more analytic engine(s) in the system. A location of the first subscriber may be determined in relation to a first network domain at 730. In various embodiments, network domains may include cell locations, tracking areas, routing/location areas, paging areas combinations thereof or the like. One or more ad domains may be identified in relation to the first subscriber based on the first network domain at 740. As noted, one or more ad domains may be aligned to one or more network domains for the communication system 10. In an embodiment, state information, including location information for the first subscriber in relation to the one or more ad domains may be stored at 742. A modeling function may be determined at 750 based, at least in part, on the mobility event message and the location of the first subscriber in relation to the identified one or more advertising domains.

Based on the modeling function, one or more demographic models for each of the identified one or more advertising domains may be updated at 760 using the demographic information and/or subscriber information for the first subscriber. Each of the one or more demographic models may include information for geographic locations within each of the one or more network domains. Each of the one or more demographic models may further include demographic and/or subscriber information for a plurality of other subscribers in each of the identified one or more advertising domains. Following the updating using the demographic information for the first subscriber, demographic information for all subscribers for each of the one or more demographic models may be calculated at 770 for each of the identified one or more advertising domains. Additionally, certain metrics may be calculated for the models. For example, a reach metric can be calculated as an intersection across multiple models in order to determine a potential number of subscribers for a particular demographic that may be exposed to a particular campaign targeted to the demographic. Further, a frequency metric can be calculated following the communication of one or more advertising campaigns targeted to the demographic.

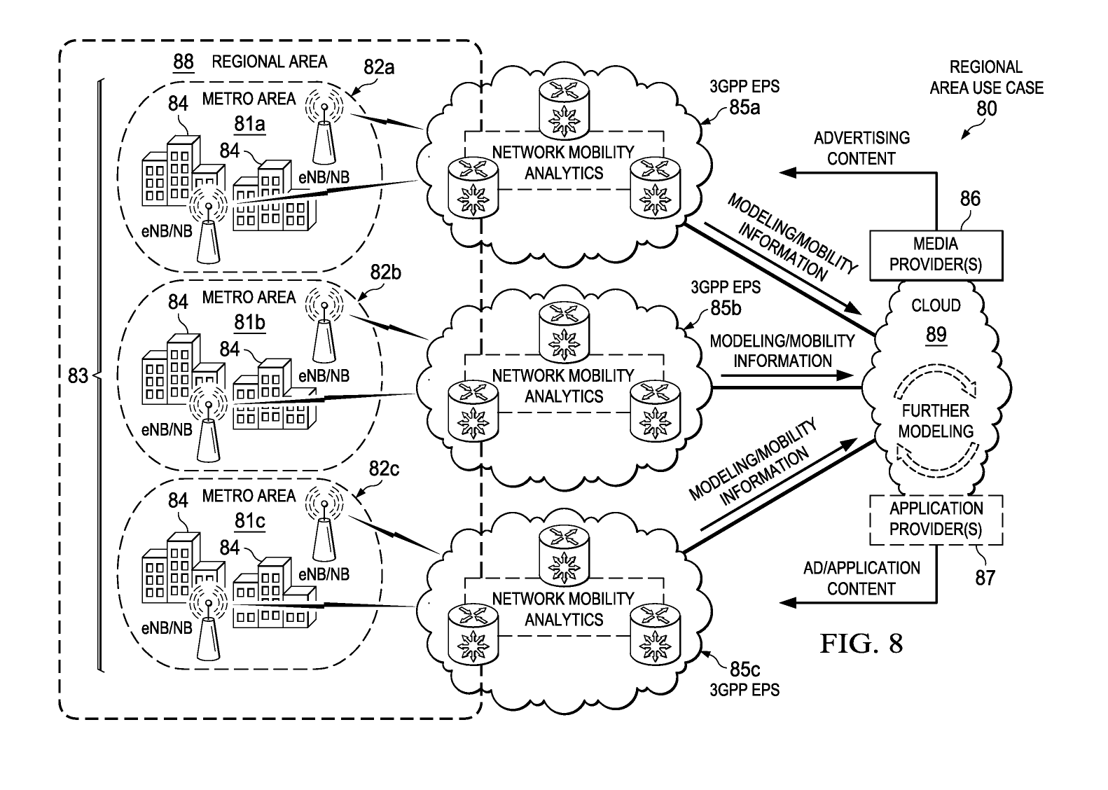

As noted, modeling information including network mobility information may be aggregated across multiple communication systems for regional areas including one or more ad domains in order to target dense populations of demographics for targeted advertising campaigns. Turning to FIG. 8, FIG. 8 is a simplified block diagram illustrating details associated with another example use case 80 in which network mobility events and corresponding analytical modeling information can be aggregated for one or more subscribers across a regional area 88 metro areas 81a-c. FIG. 8 includes three 3GPP evolved packet systems 85a-c, which may serve/provide mobile communication coverage for each of the metro areas.

A first 3GPP EPS 85a may serve metro area 81a using one or more eNBs and/or NBs. The first EPS 85a may be associated with an ad domain 82a. A second 3GPP EPS 85b may serve metro area 81b using one or more eNBs and/or NBs. The second EPS 85b may be associated with an ad domain 82b. A third 3GPP EPS 85c may serve metro area 81c using one or more eNBs and/or NBs. Another ad domain 83 may be associated with all the metro areas 81a-c. It is understood that each of the metro area may have associated thereto one or more other ad domains as described above for local and metro areas as discussed for FIGS. 5 and 6. It is further understood that the ad domains shown in FIG. 8 are provided for illustrative purposes only and ad domains for the systems may include any combination of network domains, including but not limited to, one or more cells, one or more tracking areas, one or more routing areas, one or more paging areas, combinations thereof or the like.

Each of the systems 85a-c may include one or more analytic engine(s) provisioned in the respective systems, either within one or more MAEs, port sniffers and/or other nodes/elements/gateways in any configuration, depending on use case, as described above in FIGS. 1-4, for performing network mobility analytics as described throughout the present disclosure, however, the one or more analytic engine(s) are not shown in FIG. 8 in order to illustrate other features of use case 80. The system 85a-c may include one or more PGW, HSS, EIR, SGW, PCRF, MME, one or more eNodeB and/or port sniffer as shown in FIGS. 1-4, depending on use case; however these network nodes/elements/gateways are not shown in FIG. 8 in order to Illustrate other features of use case 80. Each of the systems 85a-c may be coupled to the Internet through one or more IP services, which may connect the systems 85a-c to a cloud 89. One or more media provider(s) 86 may be connected to the cloud 89. In some embodiments, one or more application provider(s) 87 may also be connected to the cloud 89.

Each metro area 81a-c may include one or more geographic mapping element(s) 84 that may be overlaid, mapped or indexed to one or more demographic and/or population analytical models that may be built or maintained using one or more analytic engine(s) within systems 85a-c for ad domains 82a-c and associated network domains/locations for each system 85a-c. Geographic mapping element(s) 84 for each metro area 81a-c may be retrieved for one or more mapping APIs. In various embodiments, mapping elements may correspond to businesses or other retail establishments, schools, places of employment, residential dwellings, roads, highways, mass transit routes combinations thereof or the like. Generally, any location, which may be obtained from one or more publicly available mapping APIs may be indexed to one or more demographic analytical models using one or more CBM custom aggregate models for ad/network domains. Further, one or more DMAs may be overlaid, mapped or indexed to one or more demographic and/or population analytical models that may be build or maintained for the ad domains and associated network domains/locations.

The analytic engine(s) within systems 85a-c may monitor, intercept, snoop or receive mobility event messages for respective subscribers in each system 85a-c and may operate to perform a set of modeling functions based on the messages for one or more demographics and/or population analytical models for each respective ad domain 82a-c to compute real-time or approximately real-time advertising demographics for each respective metro area 81a-c. Individual UE are not shown in FIG. 8, but it is understood that each system for metro area may serve multiple UE, which can be associated to subscribers within each metro area. The analytic engines within each system 85a-c may update one or more already-established analytical models with the subscriber's information, including any demographic information for the subscriber that may be available to the analytic engine(s), for respective ad domains 82a-c and/or locations in the ad domains as mapped to corresponding CBM location indexes for the analytical models. Upon updating the demographic information for a corresponding analytical model, the model may be re-computed by corresponding analytic engine(s) to extract certain pre-determined demographic and/or population information from the models. Additionally, certain metrics can be calculated including reach and frequency metrics based on the models.

One or more analytic engine(s) for each system 85a-c may communicate modeling/mobility information to the cloud 89. The modeling/mobility information may include demographic and/or population information for subscribers in respective ad domains 82a-c. Using the modeling/mobility information from each system 85a-c, further demographic and/or population modeling may be performed in the cloud 89 to determine demographic and/or population information for ad domain 83. For example, additional reach and/or frequency metric calculations. Additionally, the cloud-based modeling may be used to identify and/or aggregate additional information together with the modeling/mobility information from each system 85a-c for use in one or more targeted advertising campaigns for ad domains 82a-c and 83 for media provider(s) 86. One or more advertising campaigns may also be targeted to local areas, or any other network domain and corresponding ad domain area within each metro area 81a-c based on the aggregated modeling/mobility information for systems 85a-c. Advertising content may be communicated to subscribers in ad domains 82a-c and/or 83 through linear television, web media outlets and/or back through the mobile systems 85a-c as shown in FIG. 8.

In some embodiments, network mobility information may be reported from one or more analytic engine(s) in the communication system 10 to one or more application provider(s) 87 through the Internet/cloud. Various types of mobility information, as described above, may be reported to application provider(s) 87 for UE within each system 85a-c based on mobility event messages monitored, received or intercepted for the UE by one or more analytic engine(s) in each system 85a-c. In various embodiments, the mobility information for UE may be used by application provider(s) 87 in order to, for example, target advertising content to certain/all subscribers associated with the UE, target application content offerings to certain/all subscribers associated with the UE, target additional application offerings to certain/all subscribers associated with the UE and/or learn behavior information, such as potential interests, lifestyle, employment, leisure or other information about the subscribers.

Aggregation of network mobility information across multiple mobile systems across regional areas and/or extra-regional areas may provide enhanced demographic and/or population modeling information for broad populations, which may be used in sophisticated ad campaigns to target dense populations of demographics either over mobile networks directly, through linear TV channels and/or through the Internet for targeted advertising campaigns and/or application content delivery, depending on use case, for media providers, advertisers, application providers, etc.

Note that with the examples provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures. Additionally, although described with reference to particular scenarios, where an analytic engine are provided within the network elements, these elements can be provided externally, or consolidated and/or combined in any suitable fashion. In certain instances, an analytic may be provided in a single proprietary unit.

It is also important to note that the steps in the appended diagrams illustrate only some of the possible signaling scenarios and patterns that may be executed by, or within, communication system 10. Some of these steps may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings provided herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for a communication network comprising:
receiving a mobility event message for a first user equipment;
determining demographic information for a first subscriber associated with the first user equipment based on subscription information for the first subscriber;
determining a location of the first subscriber in relation to a first network domain;
identifying one or more advertising domains in relation to the location of the first subscriber based on the first network domain, wherein each of the one or more advertising domains are aligned to one or more network domains of the communication network;
determining a modeling function based on the mobility event message and the location of the first subscriber in relation to the one or more identified advertising domains;
updating, based on the modeling function, one or more demographic models for each of the one or more identified advertising domains using the demographic information for the first subscriber, wherein each of the one or more demographic models includes information for geographic locations within each of the one or more network domains and wherein each of the one or more demographic models further includes demographic information for a plurality of other subscribers in each of the one or more identified advertising domains; and
following the updating, calculating demographic information for all subscribers for each of the one or more updated demographic models for each of the one or more identified advertising domains.

2. The method of claim 1, wherein the one or more demographic models further include a plurality of bitmaps compressed into a bitmap index and wherein the bitmap index includes the geographic locations indexed to the one or more network domains for each of the one or more identified advertising domains.

3. The method of claim 1, further comprising:
storing location information for the first subscriber based on the location of the first subscriber in relation to the one or more advertising domains.

4. The method of claim 1, wherein the modeling function is at least one of:
a create modeling function, wherein the updating the one or more demographic models using the demographic information for the first subscriber includes adding the demographic information for the first subscriber to at least one demographic model for at least one of the identified advertising domains;
a change modeling function, wherein the updating the one or more demographic models using the demographic information for the first subscriber includes adding the demographic information for the first user to at least one demographic model for at least one of the identified advertising domains and removing the demographic information for the first user from at least one other demographic model for at least one of the identified advertising domains; and
a delete modeling function, wherein the updating the one or more demographic models using the demographic information for the first subscriber includes removing the demographic information for the first subscriber from at least one demographic model for at least one of the identified advertising domains.

5. The method of claim 1, further comprising:
communicating advertising content to the first subscriber using a second network different than the communication network based on the location of the subscriber within one or more of the identified advertising domains.

6. The method of claim 1, wherein the calculating further comprises calculating a reach metric for a particular demographic of subscribers across an intersection of a plurality of demographic models.

7. The method of claim 1, further comprising:
communicating advertising content to a particular demographic of subscribers using a second network different than the communication network; and
calculating a frequency metric for the particular demographic of subscribers following the communicating.

8. The method of claim 1, further comprising:
communicating advertising content to the first subscriber using a linear television network.

9. The method of claim 1, wherein the receiving is performed in-band with the mobility event message.

10. The method of claim 1, wherein the receiving is performed out-of-band from the mobility event message.

11. The method of claim 1, wherein the mobility event message is received by a port sniffer that includes an analytic engine.

12. The method of claim 1, wherein the first network domain is at least one of: one or more cell locations; one or more tracking areas; one or more routing areas; and one or more paging areas.

13. The method of claim 1, wherein the mobility event message is at least one of: a handover message; a location reporting procedure message; a location management procedure message; and a subscriber data handling procedure message.

14. The method of claim 1, wherein the one or more ad domains define one or more geographic segmentations based on respective zip codes for each geographic segmentation.

15. One or more non-transitory tangible media encoding logic that include instructions for execution that, when executed by a processor, is operable to perform operations comprising:
receiving a mobility event message for a first user equipment;
determining demographic information for a first subscriber associated with the first user equipment based on subscription information for the first subscriber;
determining a location of the first subscriber in relation to a first network domain;
identifying one or more advertising domains in relation to the location of the first subscriber based on the first network domain, wherein each of the one or more advertising domains is aligned to one or more network domains of a communication network;
determining a modeling function based on the mobility event message and the location of the first subscriber in relation to the one or more identified advertising domains;
updating, based on the modeling function, one or more demographic models for each of the one or more identified advertising domains using the demographic information for the first subscriber, wherein each of the one or more demographic models includes information for geographic locations within each of the one or more network domains and wherein each of the one or more demographic models further includes demographic information for a plurality of other subscribers in each of the one or more identified advertising domains; and
following the updating, calculating demographic information for each of the one or more updated demographic models for the one or more identified advertising domains.

16. The media of claim 15, wherein the one or more demographic models further include a plurality of bitmaps compressed into a bitmap index and wherein the bitmap index includes the geographic locations indexed to the one or more network domains for each of the one or more identified advertising domains.

17. The media of claim 15, wherein the modeling function is at least one of:
a create modeling function, wherein the operations for the updating the one or more demographic models using the demographic information for the first subscriber includes adding the demographic information for the first subscriber to at least one demographic model for at least one of the identified advertising domains;
a change modeling function, wherein the operations for the updating the one or more demographic models using the demographic information for the first subscriber includes adding the demographic information for the first subscriber to at least one demographic model for at least one of the identified advertising domains and removing the demographic information for the first subscriber from at least one other demographic model for at least one of the identified advertising domains; and
a delete modeling function, wherein the operations for the updating the one or more demographic models using the demographic information for the first subscriber includes removing the demographic information for the first subscriber from at least one demographic model for at least one of the identified advertising domains.

18. An apparatus, comprising:
an analytic engine;
a memory element for storing data; and
a processor that executes instructions associated with the data, wherein the processor and memory element cooperate such that the apparatus is configured for:
receiving, at the apparatus, a mobility event message for a first user equipment;
determining, by the analytic engine, demographic information for a first subscriber associated with the first user equipment based on subscription information for the first subscriber;
determining a location of the first subscriber in relation to a first network domain;
identifying one or more advertising domains in relation to the location of the first subscriber based on the first network domain, wherein each of the one or more advertising domains is aligned to one or more network domains of a communication network;
determining a modeling function based on the mobility event message and the location of the first subscriber in relation to the one or more identified advertising domains;
updating, based on the modeling function, one or more demographic models for each of the one or more identified advertising domains using the demographic information for the first subscriber, wherein each of the one or more demographic models includes information for geographic locations within each of the one or more network domains and wherein each of the one or more demographic models further includes demographic information for a plurality of other subscribers in each of the one or more identified advertising domains; and
following the updating, calculating demographic information for each of the one or more updated demographic models for the one or more identified advertising domains.

19. The apparatus of claim 18, wherein the one or more demographic models include a plurality of bitmaps compressed into a bitmap index and wherein the bitmap index includes the geographic locations indexed to the one or more network domains for each of the one or more identified advertising domains.

20. The apparatus of claim 18, further comprising:
communicating advertising content to the first subscriber using a linear television network.
